(19) United States
(12) Patent Application Publication
(10) Pub. No.: US 2014/0253544 A1
(43) Pub. Date: Sep. 11, 2014

(54) MEDICAL IMAGE PROCESSING APPARATUS

(71) Applicants: Toshiba Medical Systems Corporation, Otawara-shi (JP); Kabushiki Kaisha Toshiba, Minato-ku, Tokyo (JP)

(72) Inventors: Kazumasa Arakita, Nasushiobara-shi (JP); Shinsuke Tsukagoshi, Nasushiobara-shi (JP)

(73) Assignees: Kabushiki Kaisha Toshiba, Minato-ku, Tokyo (JP); Toshiba Medical Systems Corporation, Otawara-shi Tochigi (JP)

(21) Appl. No.: 14/238,588

(22) PCT Filed: Jan. 24, 2013
(86) PCT No.: PCT/JP2013/051438

§ 371 Date: Feb. 12, 2014

(30) Foreign Application Priority Data
Jan. 27, 2012 (JP) 2012-015118
Feb. 24, 2012 (JP) 2012-038326

(51) Int. Cl. G06T 7/00; G06T 15/00

(52) U.S. Cl. CPC G06T 7/0012; G06T 15/00
USPC 345/419

(57) ABSTRACT

A medical image processing apparatus, which makes it possible to simply ascertain a positional relationship between images referenced for diagnostic purposes, is provided. The medical image processing apparatus in the embodiments comprises an acquisition unit, an image formation unit, a generating unit, a display and a controller. The acquisition unit scans a subject, and acquires three-dimensional data. The image formation unit forms a first image and a second image by reconstructing the acquired data according to first image generation conditions and second image generation conditions. The generating unit generates positional relationship information indicating the positional relationship between the first image and second image, based on the acquired data. The controller causes display information, based on the positional relationship information, to be displayed on the display.

### FIELD OF THE INVENTION

The embodiments of the present invention relate to a medical image processing apparatus.

### BACKGROUND ART

Medical image acquisition is the process by which an apparatus scans a subject to acquire data, and then generates an internal image of the subject based on the acquired data. An X-ray CT (Computed Tomography) apparatus, for example, is an apparatus which scans the subject with X-rays to acquire data, then processes the acquired data using a computer in order to generate an internal image of the subject.

Specifically, the X-ray CT apparatus exposes X-rays onto the subject from different angles multiple times, detects the X-rays penetrating the subject to an X-ray detector, and acquires multiple detection data. The acquired detection data is A/D converted by a data acquisition unit before being transmitted to a data processing system. The data processing system pre-processes, and the like, the detection data to form projection data. Next, the data processing system performs reconstruction processing based on the projection data to form tomographic image data. The data processing system additionally performs further reconstruction processing to form volume data based on multiple sets of tomographic image data. The volume data is a data set that expresses the three-dimensional CT value distribution corresponding to the three-dimensional area of the subject.

Reconstruction processing is conducted by applying arbitrarily set reconstruction conditions. Furthermore, using various reconstruction conditions, it is possible to form multiple sets of volume data from a single set of projection data. Reconstruction conditions include FOV (field of view), reconstruction function, and the like.

X-ray CT apparatuses can display MPR (Multi Planar Reconstruction) by rendering the volume data in an arbitrary direction. The cross-section image displayed as an MPR image can be either an orthogonal three-axis image or an oblique image. Orthogonal three-axis images include axial images, which depict an orthogonal cross-section with respect to the body axis of the subject, sagittal images, which depict a vertical cross-section along the body axis, and coronal images, which depict a horizontal cross-section along the body axis. Oblique images are cross-sections taken at any angle other than orthogonal three-axis images. Furthermore, X-ray CT apparatuses can form a pseudo three-dimensional image viewing the three-dimensional area of the subject from an arbitrary ray, by configuring the arbitrary ray and rendering the volume data.

### PRIOR ART DOCUMENT

### Patent Document

[Patent Document 1] Japanese Unexamined Application Publication No. 2005-95328

### SUMMARY OF THE INVENTION

### Problems to be Solved by the Invention

Multiple images (MPR images, pseudo three-dimensional images, and the like) that have been acquired from volume data under various reconstruction conditions are referenced during image diagnosis. These images differ in terms of the size of the area viewed, the perspective position, the position of the cross-section, and the like. As a result, it can be extremely difficult to ascertain the positional relationship between these images during diagnosis. It is also difficult to ascertain under what reconstruction conditions each of the images has been acquired.

The present invention intends to provide a medical image processing apparatus that solves the issue of facilitating the easy ascertaining of the positional relationship between images referred to in diagnosis.

### Means of Solving the Problems

The medical image processing apparatus described in the embodiments comprises an acquisition unit, an image formation unit, a generating unit, a display and a controller. The acquisition unit forms a first image and a second image by reconstructing acquired data according to first image generation conditions and second image generation conditions. The generating unit generates positional relationship information indicating the positional relationship between the first and the second images, based on the acquired data. The controller causes the display to display on display information.

### BRIEF DESCRIPTION OF THE DRAWINGS

FIG. 1 is a block diagram depicting a configuration of an X-ray CT apparatus in an embodiment.

FIG. 2 is a flow chart depicting an operation example of the X-ray CT apparatus in the embodiment.

FIG. 3 is an outline drawing explaining an operation example of the X-ray CT apparatus in the embodiment.

FIG. 4 is an outline drawing explaining an operation example of the X-ray CT apparatus in the embodiment.

FIG. 5A is an outline drawing explaining an operation example of the X-ray CT apparatus in the embodiment.

FIG. 5B is an outline drawing explaining an operation example of the X-ray CT apparatus in the embodiment.

FIG. 5C is an outline drawing explaining an operation example of the X-ray CT apparatus in the embodiment.

FIG. 6 is a flow chart depicting an operation example of the X-ray CT apparatus in the embodiment.

FIG. 7 is an outline drawing explaining an operation example of the X-ray CT apparatus in the embodiment.

FIG. 8 is an outline drawing explaining an operation example of the X-ray CT apparatus in the embodiment.

FIG. 9 is a flow chart depicting an operation example of the X-ray CT apparatus in the embodiment.

FIG. 10 is an outline drawing explaining an operation example of the X-ray CT apparatus in the embodiment.

FIG. 11 is an outline drawing explaining an operation example of the X-ray CT apparatus in the embodiment.

FIG. 12 is a flow chart depicting an operation example of the X-ray CT apparatus in the embodiment.

FIG. 13 is an outline drawing explaining an operation example of the X-ray CT apparatus in the embodiment.

FIG. 14 is a block diagram depicting a configuration of the X-ray CT apparatus in the embodiment.

FIG. 15 is an outline drawing explaining an operation example of the X-ray CT apparatus in the embodiment.

FIG. 16 is an outline drawing explaining an operation example of the X-ray CT apparatus in the embodiment.

FIG. 17 is an outline drawing explaining an operation example of the X-ray CT apparatus in the embodiment.

FIG. 18 is an outline drawing explaining an operation example of the X-ray CT apparatus in the embodiment.

FIG. 19 is a flow chart depicting an operation example of the X-ray CT apparatus in the embodiment.

FIG. 20 is an outline drawing explaining an operation example of the X-ray CT apparatus in the embodiment.

FIG. 21 is an outline drawing explaining an operation example of the X-ray CT apparatus in the embodiment.

FIG. 22 is a flow chart depicting an operation example of the X-ray CT apparatus in the embodiment.

FIG. 23 is an outline drawing explaining an operation example of the X-ray CT apparatus in the embodiment.

FIG. 24 is a flow chart depicting an operation example of the X-ray CT apparatus in the embodiment.

FIG. 25 is an outline drawing explaining an operation example of the X-ray CT apparatus in the embodiment.

FIG. 26 is a flow chart depicting an operation example of the X-ray CT apparatus in the embodiment.

FIG. 27 is an outline drawing explaining an operation example of the X-ray CT apparatus in the embodiment.

### MODES FOR CARRYING OUT THE INVENTION

The following is a description of the medical image processing apparatus in the embodiments, using an X-ray CT apparatus as an example. As described in a second and subsequent embodiments, first and second embodiments may be applied to an X-ray imaging apparatus, an ultrasound imaging apparatus or an MRI apparatus.

### First Embodiment

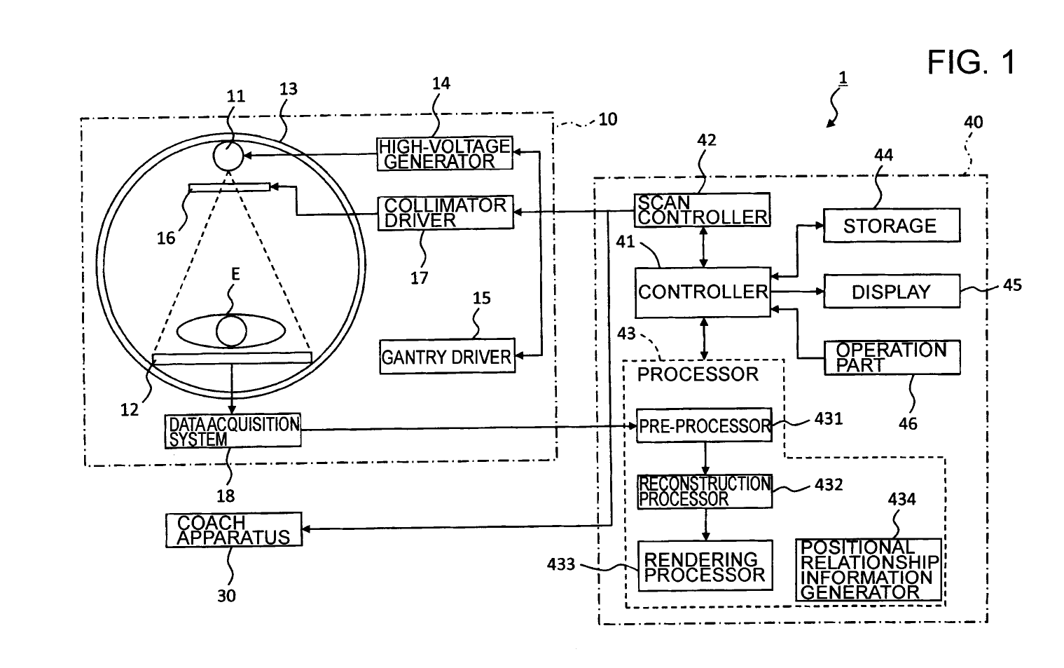

The X-ray CT apparatus in a first embodiment is described with reference to FIG. 1.

### Configuration

The following is a description of an example of the configuration of an X-ray CT apparatus 1 with reference to FIG. 1. As “image” and “image data” correspond with one another, they are sometimes viewed as the same thing.

The X-ray CT apparatus 1 comprises a gantry apparatus 10, a coach apparatus 30 and a console device 40.

### (Gantry Apparatus)

The gantry apparatus 10 exposes X-rays to a subject E. Further, the gantry apparatus 10 is an apparatus that acquires X-ray detection data that has passed through the subject E. The gantry apparatus 10 comprises an X-ray generator 11, an X-ray detector 12, a rotator 13, a high-voltage generator 14, a gantry driver 15, an X-ray collimator 16, a collimator driver 17, and a data acquisition unit 18.

The X-ray generator 11 is configured to include an X-ray tube that generates X-rays (for example, a conical or pyramid-shaped beam-emitting vacuum tube. Not shown). The generated X-rays are exposed to the subject E.

The X-ray detector 12 is configured to include multiple X-ray detection elements (not shown). The X-ray detector 12 detects X-ray strength distribution data, which indicates the strength distribution for the X-rays passing through the subject E (hereinafter, may be referred to as “detection data”) using X-ray detection elements. Furthermore, the X-ray detector 12 outputs the detection data as a current signal.

The X-ray detector 12 can be, for example, a two-dimensional X-ray detector (plane detector), in which multiple detection elements are positioned in each of two orthogonal directions (slice direction and channel direction). The multiple X-ray detection elements may, for example, be arranged in 320 rows in the slice direction. Using this type of multi-row X-ray detector allows the acquisition of an image of a three-dimensional area with a width in the slice direction with a single scan rotation (a volume scan). Repeated implementation of the volume scan allows the acquisition of a video image of the three-dimensional area of the subject (a 4D scan). The slice direction is equivalent to the rostrocaudal direction of the subject E. Further, the channel direction is equivalent to the rotation direction of the X-ray generator 11.

The rotator 13 supports the X-ray generator 11 and the X-ray detector 12 in their positions on opposing sides of the subject E. The rotator 13 has an opening all the way through in the slice direction. A top on which the subject E is placed enters the opening. The rotator 13 rotates in a circular orbit centered on the subject E by the gantry driver 15.

The high-voltage generator 14 applies a high voltage to the X-ray generator 11. The X-ray generator 11 generates X-rays based on this high voltage. The X-ray collimator 16 forms a slit (opening). The X-ray collimator 16 changes the size and shape of the slit in order to adjust the X-ray fan angle and the X-ray cone angle, the X-rays being output from the X-ray generator 11. The fan angle indicates the spread angle of the channel direction. The cone angle indicates the spread angle of the slice direction. The collimator driver 17 drives the X-ray collimator 16 to change the size and shape of the slit.

The data acquisition unit 18 (DAS) acquires detection data from the X-ray detector 12 (each of the X-ray detection elements). Further, the data acquisition unit 18 converts the acquired detection data (current signal) into a voltage signal, and cyclically integrates and amplifies the voltage signal in order to convert the signal into a digital signal. The data acquisition unit 18 transmits the detection data that has been converted into a digital signal to the console device 40.

### (Coach Apparatus)

A top of the coach apparatus 30 (not shown) has the subject E placed thereon. The coach apparatus 30 transfers the subject E placed on the top in the rostrocaudal direction. The coach apparatus 30 also transfers the top in the vertical direction.

### (Console Device)

The console device 40 is used to input operating instructions with respect to the X-ray CT apparatus 1. Further, the console device 40 reconstructs the CT image data, which expresses the internal form of the subject E, from the detection data input from the gantry apparatus 10. The CT image data includes tomographic image data, volume data, and the like. The console device 40 comprises a controller 41, a scan controller 42, a processor 43, a storage 44, a display 45 and an operation part 46.

The controller 41, the scan controller 42 and the processor 43 are configured to include, for example, a processing device and a storage device. The processing device may be, for example, a CPU (Central Processing Unit), a GPU (Graphic Processing Unit) or an ASIC (Application Specific Integrated Circuit). The storage device may be configured to include, for example, ROM (Read Only Memory), RAM (Random Access Memory) or a HDD (Hard Disc Drive). The storage device stores computer programs used to implement the various functions of the X-ray CT apparatus 1. The processing device realizes the aforementioned functions by implementing those computer programs. The controller 41 controls each part of the apparatus.

The scan controller 42 provides integrated control of the X-ray scan operations. This integrated control includes control of the high-voltage generator 14, the gantry driver 15, the collimator driver 17 and the coach apparatus 30. Control of the high-voltage generator 14 involves controlling the high-voltage generator 14 to apply the specified high voltage at the specified timing to the X-ray generator 11. Control of the gantry driver 15 involves controlling the gantry driver 15 to drive the rotation of the rotator 13 at the specified timing and at the specified speed. Control of the collimator controller 17 involves controlling the collimator driver 17 such that the X-ray collimator 16 forms a slit of a specific size and shape. The coach apparatus 30 is controlled to transfer the top to the specified position at the specified timing. In a volume scan, the scan is implemented while the top is in a fixed position. Further, in a helical scan, the scan is implemented while transferring the top. Furthermore, in a 4D scan, scanning is carried out repeatedly with the top in a fixed position. Additionally, in a helical scan, the scan is implemented while transferring the top.

The processor 43 implements various types of processes with regard to the detection data transmitted from the gantry apparatus 10 (data acquisition unit 18). The processor 42 is configured to include a pre-processor 431, a reconstruction processor 432, a rendering processor 433 and a positional relationship information generating unit 434.

The pre-processor 431 implements preprocesses including logarithmic conversion, offset correction, sensitivity correction, beam hardening correction, and the like. on the detection data from the gantry apparatus 10. This pre-processing generates projection data.

The reconstruction processor 432 generates CT image data based on the projection data generated by the pre-processor 431. Reconstruction processing of tomographic image data can involve the application, for example, of an arbitrary method such as the two-dimensional Fourier conversion method, or the convolution/back projection method. The volume data is generated by interpolation processing of the reconstructed multiple pieces of tomographic image data. Reconstruction processing of the volume data can include, for example, the application of an arbitrary method such as the cone beam reconstruction method, the multi-slice reconstruction method, or the enlargement reconstruction method. When implementing a volume scan using the aforementioned multi-row X-ray detector, it is possible to reconstruct volume data for a wide area.

Reconstruction processing is implemented based on preset reconstruction conditions. Reconstruction conditions can include various items (sometimes referred to as condition items). Examples of conditions items include FOV (field of view), reconstruction functions, and the like. FOV is the condition item that regulates the view size. Reconstruction functions are the condition item that regulates image quality characteristics, such as smoothing, sharpening, and the like. Reconstruction conditions may be set automatically or manually. An example of automatic settings is the method of selectively applying preset details for each part to be imaged, corresponding to an instruction to image a particular part. As an example of manual settings, firstly a specified reconstruction conditions setting screen is displayed on the display 45 via the operation part 46. The reconstruction conditions are then set from the reconstruction conditions setting screen, via the operation part 46. FOV settings are set with reference to the image based on the projection data and the scanogram. Furthermore, the specified FOV can be set automatically (for example, for cases in which the whole scan range is set as the FOV). The FOV is equivalent to one example of a “scan range.”

The rendering processor 433 may, for example, be capable of MPR processing and volume rendering. MPR processing involves specifying an arbitrary cross-section within the volume data generated by the reconstruction processor 42b, and implementing rendering processing. The MPR image data indicating this cross-section is formed as a result of this volume rendering. In volume rendering, volume data is sampled in line with the arbitrary line of view (ray) and its value (CT value) is added. As a result of this process, pseudo three-dimensional image data expressing the three-dimensional area of the subject E is generated.

The positional relationship information generating unit 434 generates positional relationship information expressing the positional relationship between the images based on the detection data output by the data acquisition unit 18. Positional relationship information is generated for cases in which multiple images with different reconstruction conditions, particularly multiple images with different FOV, are formed.

When the reconstruction conditions, including FOV, are set, the reconstruction processor 432 identifies the data area within the projection data corresponding to the specified FOV. Further, the reconstruction processor 432 implements reconstruction processing based on this data area and other reconstruction conditions. As a result, volume data is generated for the specified FOV. The positional relationship information generating unit 434 acquires positional information for this data area.

When two or more pieces of volume data are generated based on different reconstruction conditions, it is possible to acquire positional information for each piece of volume data. It is possible to coordinate between two or more sets of positional information. As specific example of this, the positional relationship information generating unit 434 uses coordinates based on a prespecified coordinates system as positional information with regard to the overall projection data. Doing so allows the position of two or more pieces of volume data to be expressed as coordinates in the same coordinates system. These coordinates (or a combination thereof) become the positional relationship information of those volume data. Furthermore, these coordinates (or a combination thereof) become the positional relationship information of the two or more images obtained by rendering those volume data.

The positional relationship information generating unit 434 can also generate positional relationship information using the scanogram instead of the projection data. In this case, the positional relationship information generating unit 434 expresses the FOV specified with reference to the scanogram using coordinates within the coordinates system predefined within the scanogram overall, in the same way as with the projection data. Positional relationship information can be generated in this way. This process can be applied not only when using the volume scan, but also with other scan formats (helical scan, and the like).

### (Storage, Display, Operation Part)

The storage 44 stores detection data, projection data, post-reconstruction processing image data, and the like. The display 45 is configured to include a display device such as an LCD (Liquid Crystal Display), and the like. The operation part 46 is used to input various types of instructions and information to the X-ray CT apparatus 1. The operation part is configured to include, for example, a keyboard, a mouse, a tracking ball, a joystick, and the like. Further, the operation part 46 may also include a GUI (Graphical User Interface) displayed on the display 45.

### Operation

The following is a description of the operation of the X-ray CT apparatus 1 in the present embodiment. Hereinafter, the first to the fourth operation examples are described. The first operation example describes a case in which two or more images with overlapping FOV are displayed. The second operation example describes a case in which an image with the maximum FOV (the global image) is used as a map indicating the distribution of FOV images (local images) included therein. The third operation example describes a case in which the FOV of two or more images are displayed as a list. The fourth operation example describes a case in which the reconstruction conditions settings are displayed.

### First Operation Example

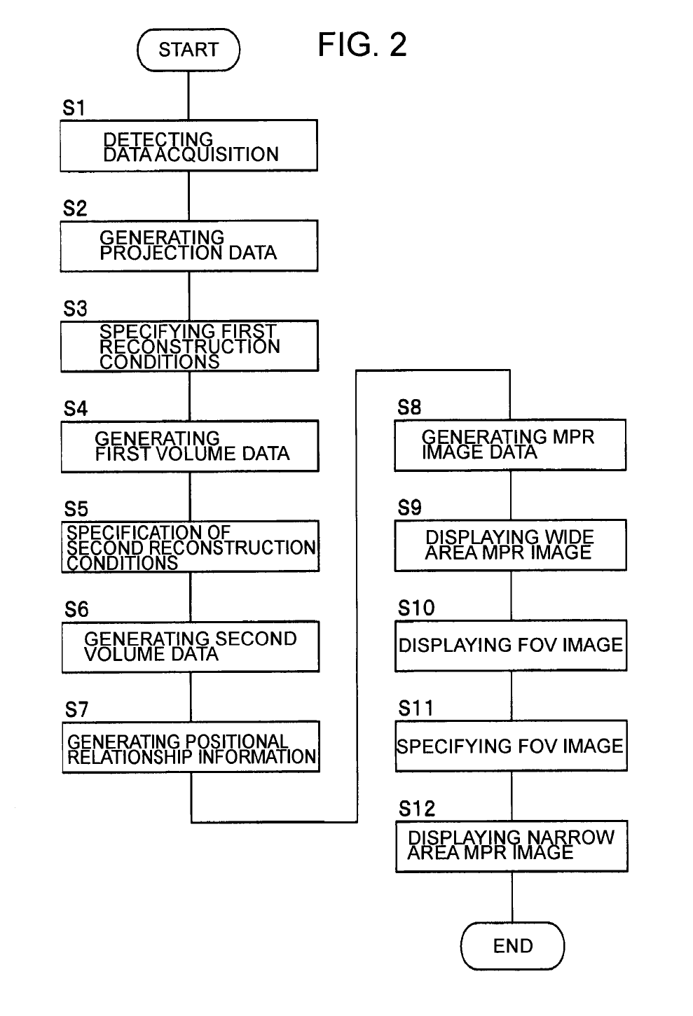

In this operation example, the X-ray CT apparatus 1 displays two or more images with overlapping FOV. The following description deals with a case in which two images with different FOVs are displayed. For cases in which three or more images are displayed, the same process is followed. FIG. 2 depicts the flow of this operation example.

### (S1: Detecting Data Acquisition)

Firstly, the subject E is placed on the top of the coach apparatus 30, and inserted into opening of the gantry apparatus 10. When the specified scan operation is begun, the controller 41 transmits a control signal to the scan controller 42. Upon receiving this control signal, the scan controller 42 controls the high-voltage generator 14, the gantry driver 15 and the collimator driver 17, and scans the subject E with X-rays. The X-ray detector 12 detects the X-rays passing through the subject E. The data acquisition unit 18 acquires the sequentially generated detection data from the X-ray detector 12 while scanning. The data acquisition unit 18 transmits the acquired detection data to the pre-processor 431.

### (S2: Generating Projection Data)

The pre-processor 431 implements the aforementioned pre-processing on the detection data from the data acquisition unit 18, and generates projection data.

### (S3: Specifying First Reconstruction Conditions)

First reconstruction conditions used to reconstruct the image are specified based on the projection data. This specification process includes specifying the FOV. The specification of FOV is implemented, for example, manually, with reference to the image based on the projection data. For the case in which a scanogram has been acquired separately, the user can specify the FOV with reference to the scanogram. Further, it is also possible to configure that a specified FOV are set automatically.

### (S4: Generating First Volume Data)

The reconstruction processor 432 implements reconstruction processing based on the first reconstruction conditions on the projection data to generate first volume data.

### (S5: Specification of Second Reconstruction Conditions)

Next, second reconstruction conditions are specified in the same way as in step 3. This specification process includes specifying the FOV.

### (S6: Generating Second Volume Data)

The reconstruction processor 432 implements reconstruction processing based on the second reconstruction conditions on the projection data to generate second volume data.

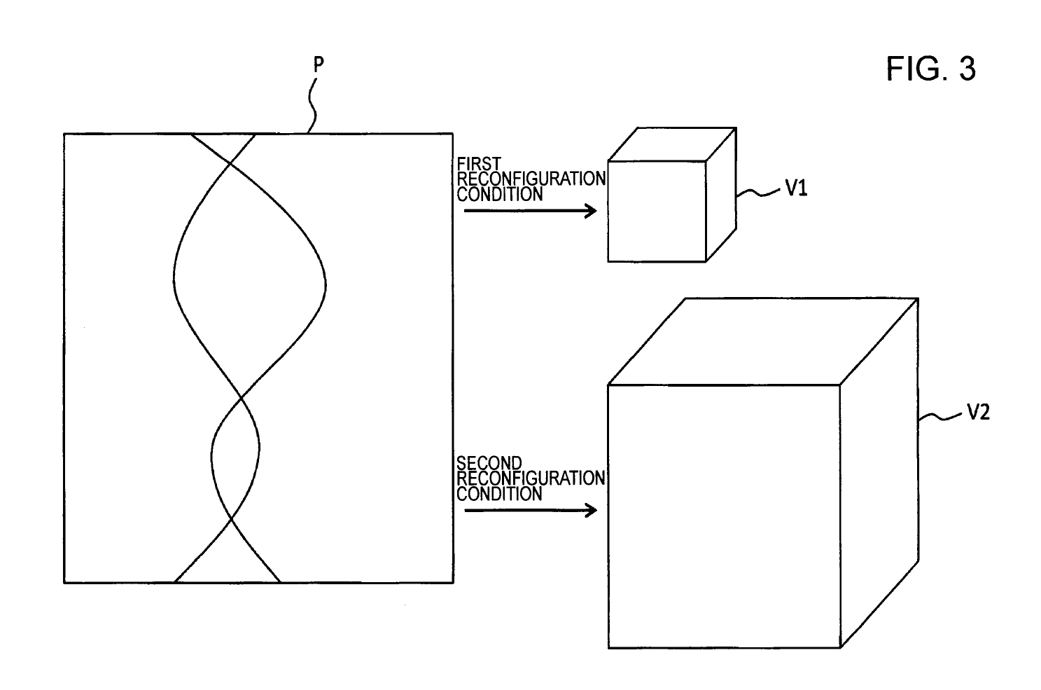

An outline of the processes in steps 3 through 6 is depicted in FIG. 3. Projection data P is subjected to reconstruction processing based on the first reconstruction conditions in the processes described above. First volume data V1 is acquired according to the first reconstruction process. Additionally, the projection data P is subjected to reconstruction processing based on the second reconstruction conditions in the processes described above. Second volume data V2 is acquired according to the second reconstruction process.

The FOV of the first volume data V1 and the FOV of the second volume data V2 overlap. Here, it is assumed that the FOV of the first volume data V1 is included within the FOV of the second volume data V2. These settings, for example, may be used when the image based on the second volume data is used to view a wide area, while the image based on the first volume data is used to focus on certain sites (internal organs, diseased areas, or the like).

### (S7: Generating Positional Relationship Information)

The positional relationship information generating unit 434 acquires positional information for the volume data at the specified FOV, based on either the projection data or the scanogram. Furthermore, the positional relationship information generating unit 434 generates positional relationship information by coordinating the two pieces of acquired positional information.

### (S8: Generating MPR Image Data)

The rendering processor 433 generates MPR image data based on the wide area volume data V2. This MPR image data is defined as wide area MPR image data. This wide area MPR image data may be one of the pieces of orthogonal three-axis image data, or it may be oblique image data based on an arbitrarily specified cross-section. Hereinafter, images based on the wide area MPR image data may be referred to as “wide area MPR images.”

Furthermore, the rendering processor 433 generates MPR image data based on the narrow area volume data V1 at the same cross-section as the wide area MPR image data. This MPR image data is defined as narrow area MPR image data. Hereinafter, images based on the narrow area MPR image data may be referred to as “narrow area MPR images.”

### (S9: Displaying Wide Area MPR Image)

The controller 41 displays wide area MPR images on the display 45.

### (S10: Displaying FOV Image)

Further, the controller 41 causes the display of the FOV image, which expresses the position of the narrow area MPR image within the wide area MPR image based on the positional relationship information related to the two of volume data V1 and V2, overlapping the wide area MPR image. The user may also display the FOV image that corresponds to the specified operation implemented by the user using the operation part 46. Furthermore, while the wide area MPR image is being displayed, the FOV image may always be displayed.

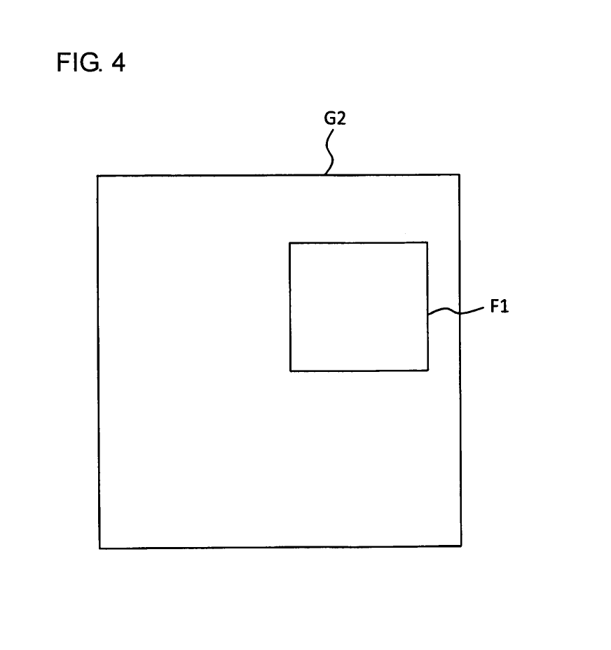

FIG. 4 depicts an example of the FOV image display. In FIG. 4, a FOV image F1 expressing the position of the narrow area MPR image within a wide area MPR image G2 is depicted superimposed on the wide area MPR image G2.

(S11: Specifying FOV image)

The user uses the operation part 46 to specify the FOV image F1 in order to display the narrow area MPR image. The designation operation is conducted, for example, by clicking on the FOV image F1 using a mouse.

### (S12: Displaying Narrow Area MPR Image)

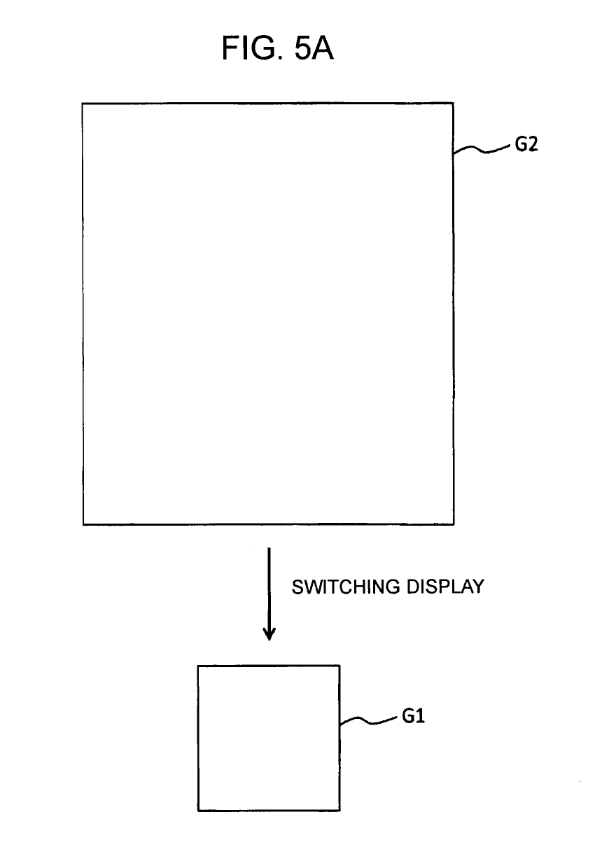

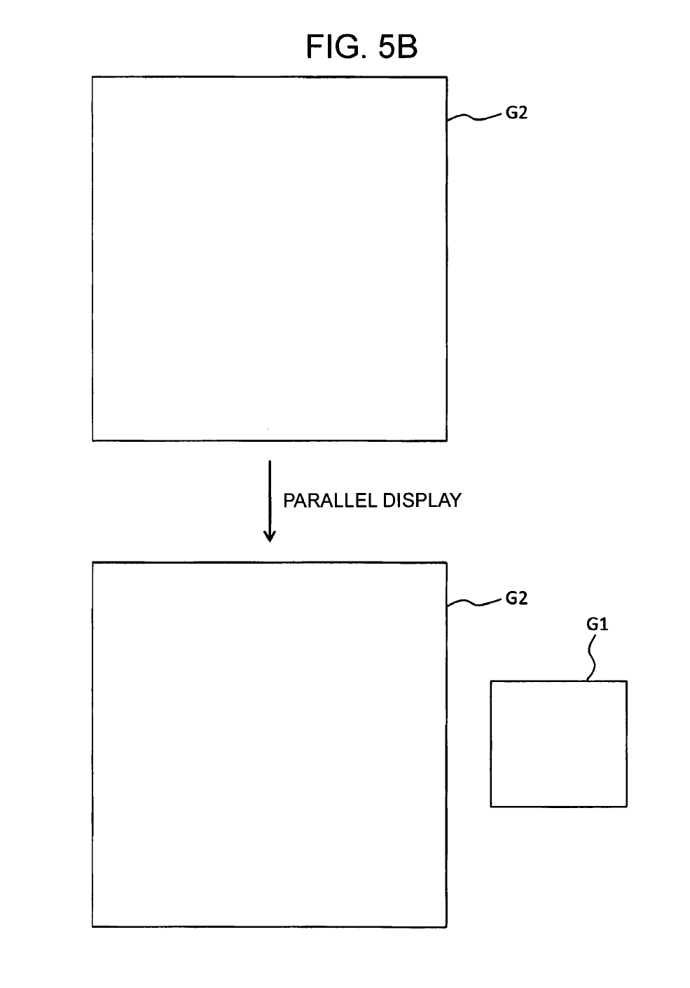

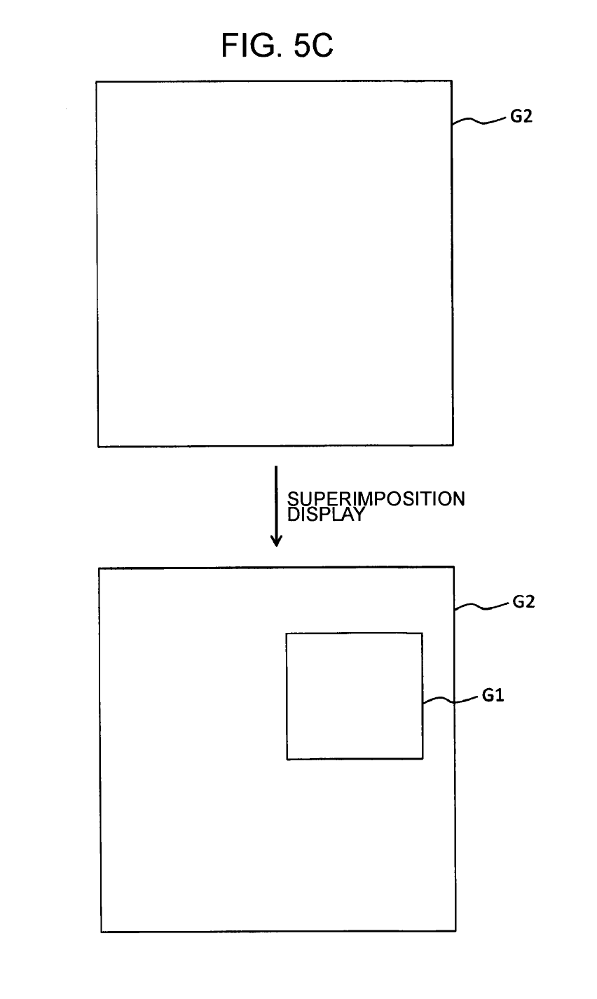

When the FOV image F1 is specified, the controller 41 causes the display 45 to display the narrow area MPR image corresponding to the FOV image F1. At this point, the display format is any one of the following: (1) As depicted in FIG. 5A, a switching display from the wide area MPR image G2 to a narrow area MPR image G1; (2) As depicted in FIG. 5B, a parallel display of the wide area MPR image G2 and the narrow area MPR image G1; or (3) As depicted in FIG. 5C, a superimposed display of the narrow area MPR image G1 on the wide area MPR image G2. In the superimposed display, the narrow area image G1 is displayed in the FOV image F1 position. The display format implemented may be preset in advance, or may be selected by the user. In the latter case, it is possible to switch between display formats in response to the operation implemented using the operation part 46. For example, in response to right-clicking the FOV image F1, the controller 41 causes the display of a pull-down menu indicating the aforementioned three display formats. When the user clicks the desired display format, the controller 41 implements the selected display format. This concludes the description of the first operation example.

### Second Operation Example

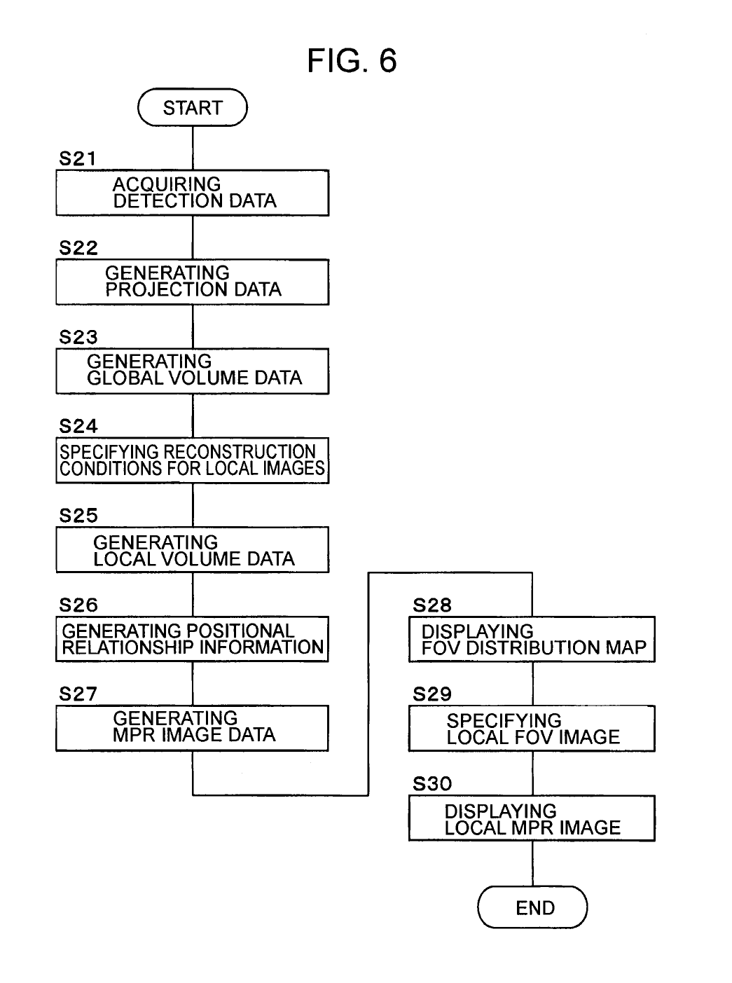

This operation example uses the global image as a map indicating the distribution of local images. Here, the description relates to the case in which the distribution of two local images with different FOVs is presented. For cases in which three or more local images are displayed, the same process can be followed. FIG. 6 depicts the flow of this operation example.

### (S21: Acquiring Detection Data)

As in the first operation example, the gantry apparatus 10 acquires detection data. Further, the gantry apparatus 10 transmits the acquired detection data to the pre-processor 431.

### (S22: Generating Projection Data)

The pre-processor 431 implements the aforementioned pre-processing on the detection data from the gantry apparatus 10, and generates projection data.

### (S23: Generating Global Volume Data)

The reconstruction processor 432 reconstructs the projection data based on the reconstruction conditions to which the maximum FOV has been applied as the FOV condition item. Based on this, the reconstruction processor 432 generates the maximum FOV volume data (global volume data).

### (S24: Specifying Reconstruction Conditions for Local Images)

Similar to the first operation example, the reconstruction conditions for each local image are specified. The FOV in the reconstruction conditions is included in the maximum FOV. Here, the reconstruction conditions for a first local image and the reconstruction conditions for a second local image are specified, respectively.

### (S25: Generating Local Volume Data)

The reconstruction processor 432 applies reconstruction processing to the projection data based on the reconstruction conditions for the first local image. Based on this, the reconstruction processor 432 generates first local volume data. Further, the reconstruction processor 432 applies to the projection data the reconstruction processing based on the reconstruction conditions for the second local image. Based on this, the reconstruction processor 432 generates second local volume data.

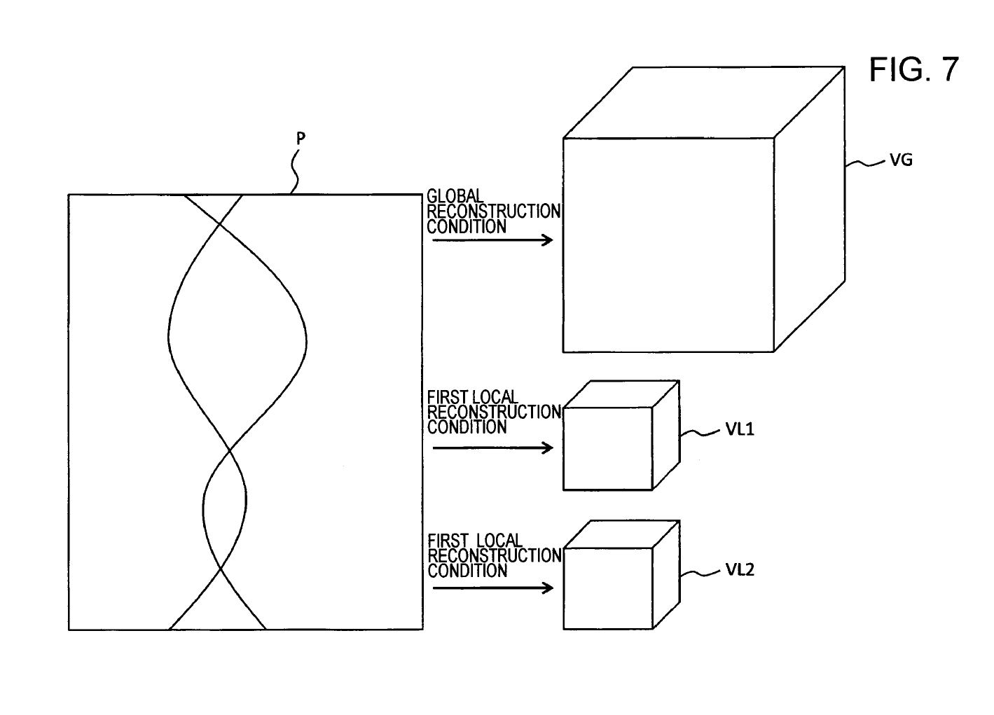

FIG. 7 depicts an outline of the processes between steps 23 and 25. According to the processes described above, the projection data P is subjected to reconstruction processing based on the reconstruction conditions of the maximum FOV (global reconstruction conditions). Global volume data VG is acquired in this way. Further, according to the process described above, the projection data P is subjected to reconstruction processing based on the reconstruction conditions of the local FOV (local reconstruction conditions) included in the maximum FOV. Local volume data VL1 and VL2 are then acquired in this way.

### (S26: Generating Positional Relationship Information)

The positional relationship information generating unit 434 acquires positional information with regard to volume data VG, VL1 and VL2 about each of the specified FOV, based on the projection data, or on the scanogram. The positional relationship information generating unit 434 also generates positional relationship information, by coordinating the three pieces of acquired positional information.

### (S27: Generating MPR Image Data)

The rendering processor 433 generates MPR image data (global MPR image data) based on the global volume data VG. This global MPR image data may be any one of the pieces of orthogonal three-axis image data, or it may be oblique image data based on an arbitrarily specified cross-section.

Further, the rendering processor 433 generates MPR image data (first local MPR image data) with regard to the cross-section that is the same as the global MPR image data, based on the local volume data VL1. Additionally, the rendering processor 433 generates MPR image data (second local MPR image data) with regard to the cross-section that is the same as the global MPR image data, based on the local volume data VL2.

### (S28: Displaying FOV Distribution Map)

The controller 41 causes the display 45 to display a map (FOV distribution map) expressing the distribution of local FOV in the global MPR image, based on the positional relationship information generated in step 26. The global MPR image is a MPR image based on the global MPR image data.

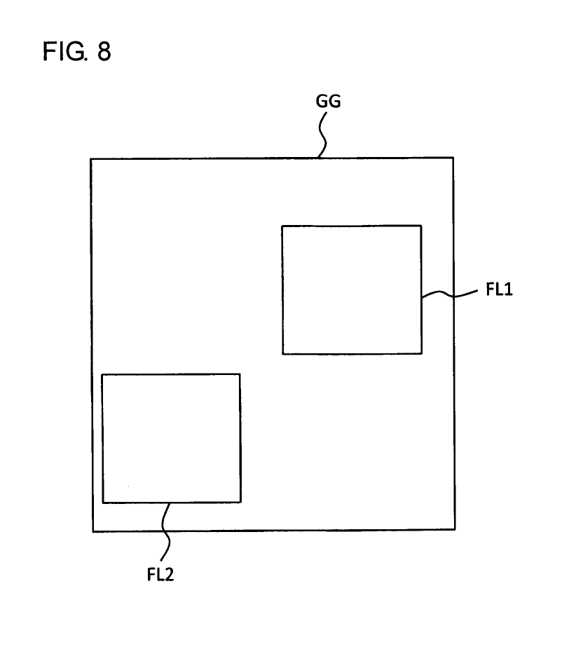

An example of an FOV distribution map is depicted in FIG. 8. A first local FOV image FL1 in FIG. 8 is an FOV image expressing the scope of the first local MPR image data. Further, a second local FOV image FL2 is an FOV image expressing the scope of the second local MPR image data. The FOV distribution map depicted in FIG. 8 displays the first local FOV image FL1 and the second local FOV image FL2, both being superimposed on a global MPR image GG. Here, the user may also display either of the local FOV images FL1 or FL2 in response to a specified operation using the operation part 46. Further, during the time that the global MPR image GG is displayed in response to the specified operation, the local FOV images FL1 and FL2 may always be displayed.

### (S29: Specifying Local FOV Image)

The user specifies the local FOV image corresponding to the local MPR image in order to display a desired local MPR image using the operation part 46. This specification operation is done, for example, by clicking the local FOV image using a mouse.

### (S30: Displaying Local MPR Image)

When the local FOV image is specified, the controller causes the display 45 to display the local MPR image corresponding to the specified local FOV image. The display format at this point may, for example, be a switching display, a parallel display or a superimposed display, similarly to those in the first operation example. This concludes the description of the second operation example.

### Third Operation Example

This operation example involves displaying two or more image FOVs in a list. Here, a description is given of the case in which the local FOVs are displayed in the maximum FOV as a list.

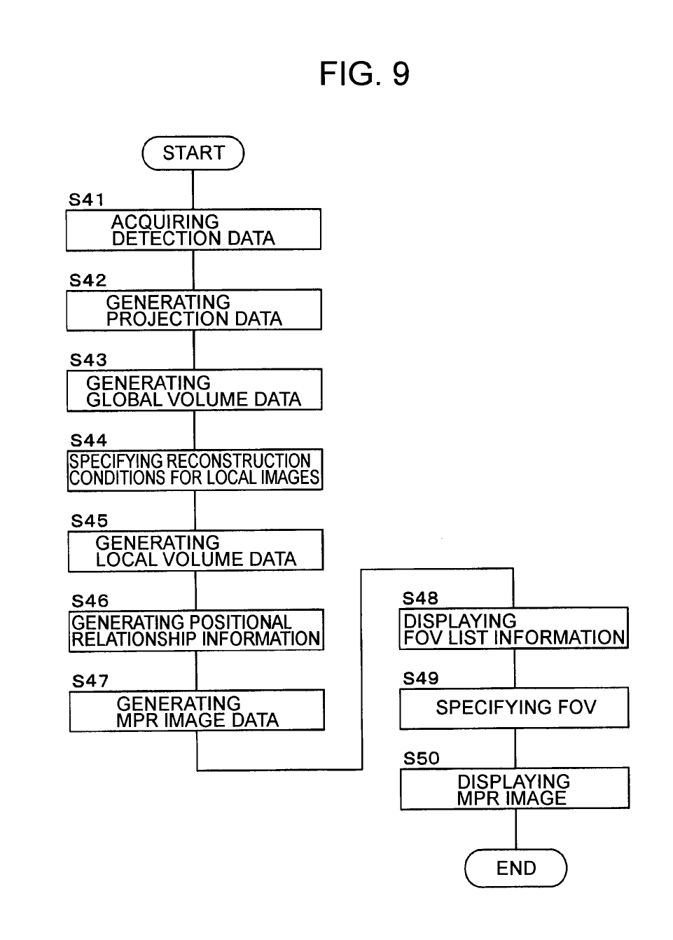

However, list display formats other than that mentioned above may also be applied. For example, it is possible to add a name to each FOV and display a list of the names (site name, internal organ name, and the like.) FIG. 9 depicts the flow of this operation example.

### (S41: Acquiring Detection Data)

Similar to the first operation example, the gantry apparatus 10 acquires detection data. Further, the gantry apparatus 10 transmits the acquired detection data to the pre-processor 431.

### (S42: Generating Projection Data)

The pre-processor 431 applies the aforementioned pre-processing on the detection data from the gantry apparatus 10, and generates projection data.

### (S43: Generating Global Volume Data)

Similar to the second operation example, the reconstruction processor 432 reconstructs the projection data based on the reconstruction conditions to which the maximum FOV has been applied. Based on this, the reconstruction processor 432 generates the global volume data.

### (S44: Specifying Reconstruction Conditions for Local Images)

Similar to the first operation example, the reconstruction conditions are specified for each local image. The FOV in the reconstruction conditions is included in the maximum FOV. Here, the reconstruction conditions for the first and second local images are specified, respectively.

### (S45: Generating Local Volume Data)

Similar to the second operation example, the reconstruction processor 432 applies reconstruction processing to the projection data based on the reconstruction conditions for the first and the second local images, respectively. Based on this, the reconstruction processor 432 generates the first and second local volume data. As a result of this process, the global volume data VG and local volume data VL1 and VL2 depicted in FIG. 7 are acquired.

### (S46: Generating Positional Relationship Information)

The positional relationship information generating unit 434 acquires positional information with regard to volume data VG, VL1 and VL2 about each of the specified FOV, based on the projection data, or on the scanogram. The positional relationship information generating unit 434 also generates positional relationship information, by coordinating the three pieces of acquired positional information.

### (S47: Generating MPR Image Data)

As in the second operation example, the rendering processor 433 generates global MPR image data, the first local MPR image data and the second local MPR image data, based on the global volume data VG.

### (S48: Displaying FOV List Information)

The controller 41 causes the display 45 to display a list of the global FOV as well as the first and second local FOV based on the positional relationship information generated in step 46. The global FOV is the FOV corresponding to the global MPR image data. Furthermore, the first local FOV is the FOV corresponding to the first local MPR image data. The second local FOV is the FOV corresponding to the second local MPR image data.

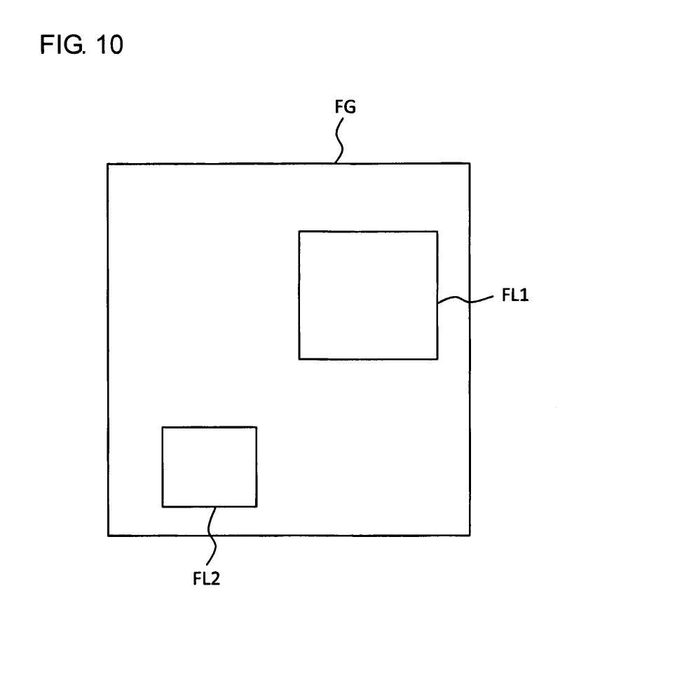

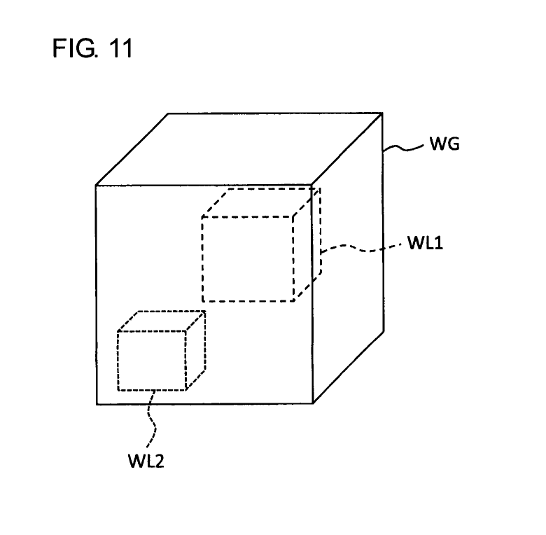

FIG. 10 depicts the first example of the FOV list information. This FOV list information presents the first local FOV image FL1 and the second local FOV image FL2 within a global FOV image FG expressing the scope of the global FOV. A second example of the FOV list information is depicted in FIG. 11. This FOV list information presents a first local volume data image WL1 and a second local volume data image WL2 within a global volume data image WG. The first local volume data image WL1 expresses the scope of the local volume data VL1. Additionally, the second local volume data image WL2 expresses the scope of the local volume data VL2. The global volume data WG expresses the scope of the global volume data VG.

### (S49: Specifying FOV)

The user specifies the FOV corresponding to the MPR image in order to display a desired MPR image using the operation part 46. This specification operation is done, for example, by clicking the global FOV image, local FOV image, local volume data image or FOV name using a mouse.

### (S50: Displaying MPR Image)

When the FOV is specified, the controller 41 causes the display 45 to display the MPR image corresponding to the specified FOV image. This concludes the description of the third operation example.

### Fourth Operation Example

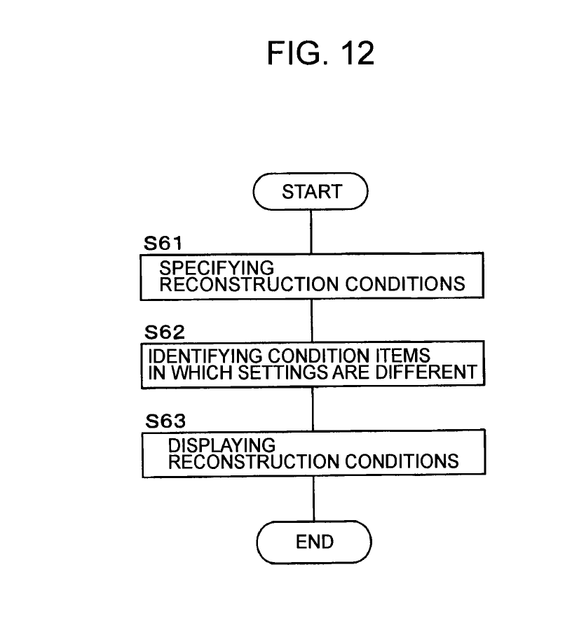

This operation example allows the reconstruction conditions settings to be displayed. Here, a description is given of cases of displaying in different formats settings in which the condition items are the same and settings in which the condition items are different for two or more reconstruction conditions. This operation example can be added to any one of the first to the third operation examples. Further, this operation example may be applied to any arbitrary operation other than these. FIG. 12 depicts the flow of this operation example. This operation example is described using a case in which two reconstruction conditions are specified. However, it is also possible to implement the same process for cases in which three or more reconstruction conditions are specified. The following description includes steps that are duplicated from the first to the third operation examples.

### (S61: Specifying Reconstruction Conditions)

The first reconstruction conditions and the second reconstruction conditions are specified. It is assumed that the condition items for each set of reconstruction conditions include the FOV and the reconstruction functions. As an example, in the first reconstruction conditions, it is assumed that the FOV is the maximum FOV. It is also assumed that the reconstruction functions are defined as pulmonary functions. Further, in the second reconstruction conditions, it is assumed that the FOV is the local FOV. It is also assumed that the reconstruction functions are defined as pulmonary functions.

(S62: Identifying Condition Items in which Settings are Different)

The controller 41 identifies condition items in which the settings are different between the first reconstruction conditions and the second reconstruction factors. In this operation example, the FOV is different but the reconstruction functions are the same, so that the FOV is identified as the condition item in which the settings are different.

### (S63: Displaying Reconstruction Conditions)

The controller 41 causes the condition items identified in step 62 and the other condition items to be displayed in different formats. The display process is implemented at the same time as the display processing of the wide area MPR image and the FOV image in the first operation example, the display processing of the FOV distribution map in the second operation example, or the display processing of the FOV list information in the third operation example.

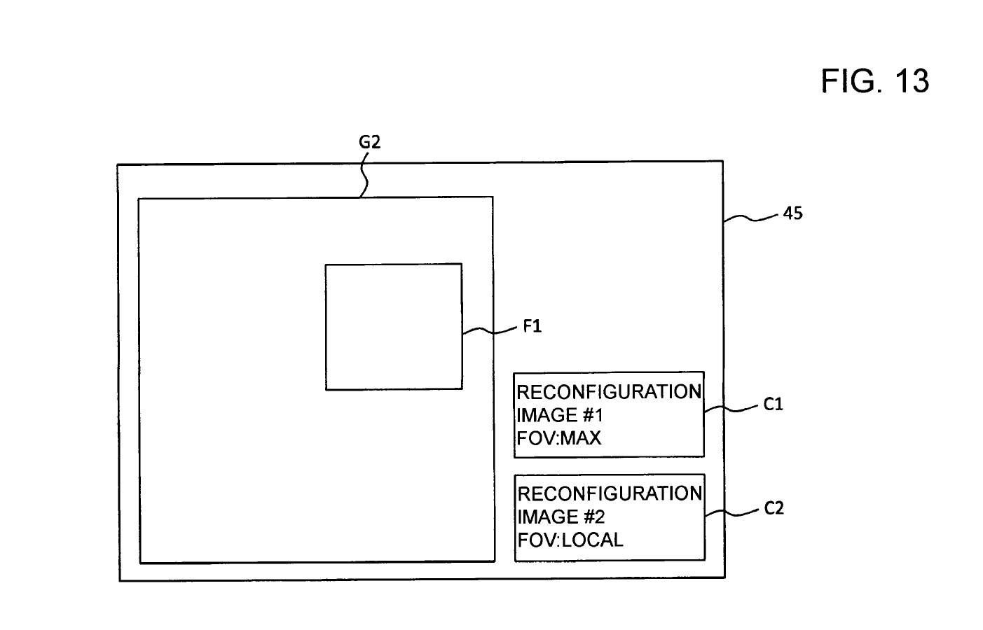

FIG. 13 depicts an example of the display of reconstruction conditions for a case in which this operation example is applied to the first operation example. The display 45 displays the wide area MPR image G2 and the FOV image F1 as depicted in the first operation example in FIG. 4.

Additionally, the display 45 has a first conditions display area C1 and a second conditions display area C2. The controller 41 causes the settings of the first reconstruction conditions, corresponding to the FOV image F1 (narrow area MPR image G1), to be displayed in the first conditions display area C1. The controller 41 also causes the settings of the second reconstruction conditions, corresponding to the wide area MPR image G2, to be displayed in the second conditions display area C2.

In this operation example, the FOV settings are different while the reconstruction function settings are the same. As a result, the FOV settings and the reconstruction function settings are presented in different formats. In FIG. 13, the FOV settings are presented in bold and underlined. Further, in FIG. 13, the reconstruction function settings are presented in standard type with no underline. The display formats are not restricted to these two types. For example, different settings may be displayed using shading, by changing the color, or using any arbitrary display format.

### Operation/Benefits

The following is a description of the operation and benefits of the X-ray CT apparatus 1 in the first embodiment.

The X-ray CT apparatus 1 comprises an acquisition unit (the gantry apparatus 10), an image formation unit (the pre-processor 431, the reconstruction processor 432, and the rendering processor 433), a generating unit (the positional relationship information generating unit 434), and the display 45 and the controller 41. The acquisition unit scans the subject E with X-rays, and acquires data. The image formation unit forms a first image by reconstructing the acquired data according to the first reconstruction conditions. The image formation unit also forms a second image by reconstructing the acquired data according to the second reconstruction conditions. The generating unit generates positional relationship information expressing the positional relationship between the first image and the second image based on the acquired data. The controller 41 causes the display 45 to display on the display information based on the positional relationship information. Examples of the display information include FOV images, FOV distribution maps and FOV list information. By referring to the display information, the X-ray CT apparatus 1 allows the positional relationship between the images reconstructed based on the different reconstruction conditions to be simply ascertained.

The generation of positional relationship information can be implemented based on the projection data or the scanogram. If a volume scan is implemented, it is possible to use either of these data. If a helical scan is implemented, the scanogram can be used.

If the positional relationship information is generated based on projection data, it is possible to apply the following configuration. The image formation unit is configured to include, as described above, the pre-processor 431, the reconstruction processor 432, and the rendering processor 433. The pre-processor 431 generates projection data by subjecting the data acquired from the gantry apparatus 10 to pre-processing. The reconstruction processor 432 subjects the projection data to reconstruction processing based on the first reconstruction conditions, to generate the first volume data. Additionally, the reconstruction processor 432 subjects the projection data to reconstruction processing based on the second reconstruction conditions, to generate the second volume data. The rendering processor 433 subjects the first volume data to rendering processing to form the first image. Additionally, the rendering processor 433 subjects the second volume data to rendering processing to form the second image. The positional relationship information generating unit 434 then generates positional relationship information based on the projection data.

At the same time, when generating positional relationship information based on the scanogram, it is possible to use the following configuration. The gantry apparatus 10 acquires the scanogram by scanning the subject E by fixing the irradiating direction of the X-ray. The positional relationship information generating unit 434 generates positional relationship information based on the scanogram.

For cases in which the first image FOV and the second image FOV overlap, it is possible to display the information expressing the position of one of the images superimposed on the other image. An example of this configuration is as follows. The first reconstruction conditions and the second reconstruction conditions include a mutually overlapping FOV as a condition item. The controller 41 causes the FOV image (display information) which expresses the first image FOV, to be displayed superimposed on the second image. As a result, the position of the first image on the second image (in other words, the positional relationship between the first image and the second image) can be easily ascertained.

For cases in which this configuration is applied, it is possible to configure the system such that the first image is displayed on the display 45 in response to the specification of the FOV image using the operation part 46. The controller 41 carries out this display process. As a result, it is possible to transition smoothly to browse the first image. One example of this display control is that the display switches from the second image to the first image. In addition, the first image and the second image may be displayed in parallel. Furthermore, the first image and the second image may be displayed superimposed on one another.

The FOV image may be displayed at all times, but it is also possible to configure the system such that the FOV image is displayed in response to user demand. In this case, the controller 41 is configured to display the FOV image superimposed on the second image in response to the operation (clicking, and the like) of the operation part 46 when the second image is displayed on the display 45. In this way, it is possible to display the FOV image only when the user wishes to confirm the first image position, or to browse the image. In so doing, the FOV image does not become an obstruction to browse the second image.

The maximum FOV image may be used as a map indicating the distribution of the local images. In one example of this configuration, the image formation unit forms a third image by reconstructing under the third reconstruction conditions, which include the maximum FOV as part of the FOV condition item settings. The controller 41 then causes the FOV image of the first image and the FOV image of the second image to be displayed superimposed on the third image. This is the FOV distribution map used as display information. Displaying this type of FOV distribution map allows the user to easily ascertain how the images acquired under the arbitrary reconstruction conditions are distributed within the maximum FOV. Even if this configuration is applied, it is possible to configure the system such that the FOV image is displayed only when required by the user. It is also possible to configure the system such that when the user specifies one of the FOV images displayed superimposed on the third image, the CT image corresponding to the specified FOV image is displayed.

It is possible to display the FOV used in diagnosis as a list. This example is not one in which the FOV image of a different CT image is displayed over a given CT image (the third image) as above, but rather in which all or some of the FOV used in diagnosis are displayed as a list. For this reason, the following can be given as a configuration example. Both the first reconstruction conditions and the second reconstruction conditions include FOV as a condition item. The controller 41 causes the display 45 to display the FOV list information (display information) including the FOV information expressing the first image FOV and the FOV information expressing the second image FOV. As a result, it becomes possible to easily ascertain how the FOV used in diagnosis are distributed. In this case, simulated images (contour images) of each of the internal organs are displayed along with the FOV images. As a result, it is also possible to facilitate awareness of the (rough) positions of each FOV. Furthermore, if the user uses the operation part 46 to specify FOV information, the controller 41 can be configured to cause the display 45 to display the CT image corresponding to the specified FOV. Each piece of FOV information is displayed, for example, within a display area equivalent to the size of the maximum FOV.

If some of the FOV used in the diagnosis are to be displayed as a list, the FOV may be categorized, for example, by internal organ, making it possible to selectively display only the FOV related to the specified internal organ. As a specific example of this, an X-ray CT apparatus categorizes all FOV applied for diagnosis of the chest, into an FOV group related to the lungs and an FOV group related to the heart. In this way, it is possible for the X-ray CT apparatus to selectively (exclusively) display each group in response to instructions from the user, and the like. Furthermore, the FOV can be categorized based on specified reconstruction settings other than FOV, making it possible to selectively display only the FOV of the specified settings. As a specific example, an X-ray CT apparatus categorizes all the FOV in its condition item “reconstruction functions” into a “pulmonary functions” FOV group and a “mediastinum functions” FOV group. In this way, it is possible to selectively (exclusively) display each group in response to instructions from the user, and the like.

It is possible to display not only the settings related to the FOV, but also arbitrary reconstruction conditions. According to this configuration, for cases in which there are different condition items in the settings between different reconstruction conditions, it is possible to cause the relevant condition item settings to be displayed in a different format from the other condition item settings. In this way, the user can easily be made aware of whether the settings are the same or different.

Next, the following is a description of the X-ray CT apparatus 1 in a second embodiment, with reference to the diagrams.

### Configuration

For the configuration of the X-ray CT apparatus 1 in the second embodiment, descriptions of the configuration same as those of the first embodiment may be omitted. In other words, the following mainly describes the parts necessary for description of the second embodiment. The following description is given with reference to FIG. 5A through FIG. 5C, FIG. 8 and FIG. 14 through FIG. 27. For image diagnosis in which a 4D scan is applied, the reconstruction conditions and other image generation conditions are specified as appropriate, while multiple volume data with different acquisition timings (time phase) is selectively rendered. As a result, not only the positional relationship and reconstruction conditions between the images are given, but also a time element is added, so that the relationship between the images becomes still more complex. Furthermore, when imaging a target whose form changes over time, such as the heart or lungs, the positional relationship between images with different acquisition timing is extremely complex. The second embodiment was developed in consideration of these problems. In other words, the second embodiment presents a medical image processing apparatus that makes it simple to ascertain the relationship between images obtained based on multiple volume data with different acquisition timing.

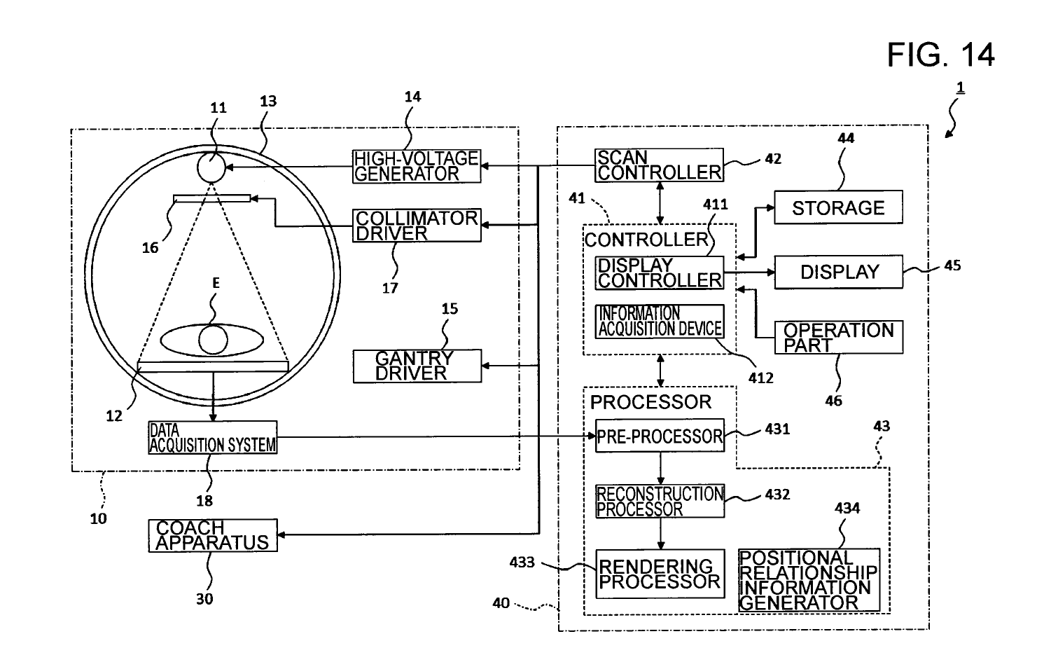

As depicted in FIG. 14, the controller 41 comprises a display controller 411 and an information acquisition device 412.

The display controller 411 controls the display 45 to display various types of information. Additionally, it is possible for the display controller 411 to implement information processing related to the display process. The processing details implemented by the display controller 411 are given below.

The information acquisition device 412 operates as an “acquisition device” when a 4D scan is implemented. In other words, the information acquisition device 412 acquires information related to acquisition timing with regard to detection data acquired continuously by the 4D scan.

Here, “acquisition timing” indicates the timing of the occurrence of events progressing over time, in parallel with continuous data acquisition by the 4D scan. It is possible to synchronize each timing included in the continuous data acquisition with the timing of the occurrence of events progressing over time. For example, a designated temporal axis is specified using a timer. Additionally, identifying coordinates on the relevant temporal axis corresponding to each timing input allows the two to be synchronized.

Examples of the above events over time include the motion state and contrast state of the internal organs of the subject E. The internal organs subject to observation may be any arbitrary organs that move, such as the heart and lungs. The movement of the heart is ascertained with, for example, an echocardiogram. The echocardiogram uses an electrocardiograph to electrically detect the motion state of the heart and express this information in waveform, depicting multiple cardiac time phases along a time series. The movement of the lungs is acquired using, for example, a breathing monitor. The breathing monitor acquires multiple time phases related to breathing, in other words, multiple time phases, related to the movement of the lungs along a time series. Further, the contrast state indicates the state of inflow of the contrast agent to the veins in an examination or surgery in which a contrast agent is being used. The contrast state includes multiple contrast timings. The multiple contrast timings are, for example, multiple coordinates on a temporal axis that takes the time at which the contrast agent was introduced as its starting point.

The “information showing acquisition timing” is information representing the above acquisition timing discriminably. The following is a description of the example of information indicating the acquisition timing. When observing the movement of the heart, for example, it is possible to use time phases such as the P waves, Q waves, R waves, S waves and U waves, in the electrocardiogram waveforms. When observing the movement of the lungs, for example, it is possible to use time phases such as exhalation (start, end), inhalation (start, end) and resting, based on the waveforms on the breathing monitor. When observing the state of contrast, for example, it is possible to define contrast timing based on the start of introduction of the contrast agent, the elapsed time since the start of introduction, and the like. Further, it is also possible to acquire the contrast timing by analyzing a particular area within the image, such as, for example, analyzing changes in the brightness in the contrast area (veins) in the imaging area of the subject E.

Furthermore, for cases in which an organ repeating a cyclical movement is imaged, it is possible to define the time phase by making the length of one cycle as criteria reference. For example, the length of a single cycle based on an electrocardiogram indicating the cyclical movement of the heart is acquired and expressed as 100%. As a specific example of this, the gap between adjacent R waves (a former R wave and a latter R wave) is defined as 100%, with the time phase of the former R wave expressed as 0% and the time phase of the latter R wave as 100%. Next, an arbitrary time phase between the time phase of the former R wave and that of the latter R wave is expressed as TP % (TP=0 to 100%).

The information acquisition device 412 acquires data from a device that is capable of detecting vital responses from the subject E (an electrocardiograph, breathing monitor, and the like (not shown)). Furthermore, the information acquisition device 412 acquires data from a dedicated device for the purpose of observing the contrast state. Alternatively, the information acquisition device 412 acquires contrast timing using a timer function of a microprocessor.

### Operation

The following is a description of the operation of the X-ray CT apparatus 1 in the present embodiment. There follows a description of the following three operations: (1) the acquisition and reconstruction processing of data; (2) the display operation based on acquisition timing (in other words, the display operation in consideration of time phases); and (3) the display operation in additional consideration of the positional relationship between images (in other words, the display operation in additional consideration of FOV). Here, multiple operation examples indicated in (2) and multiple operation examples indicated in (3) may be arbitrarily combined.

### Data Acquisition and Reconstruction Processing

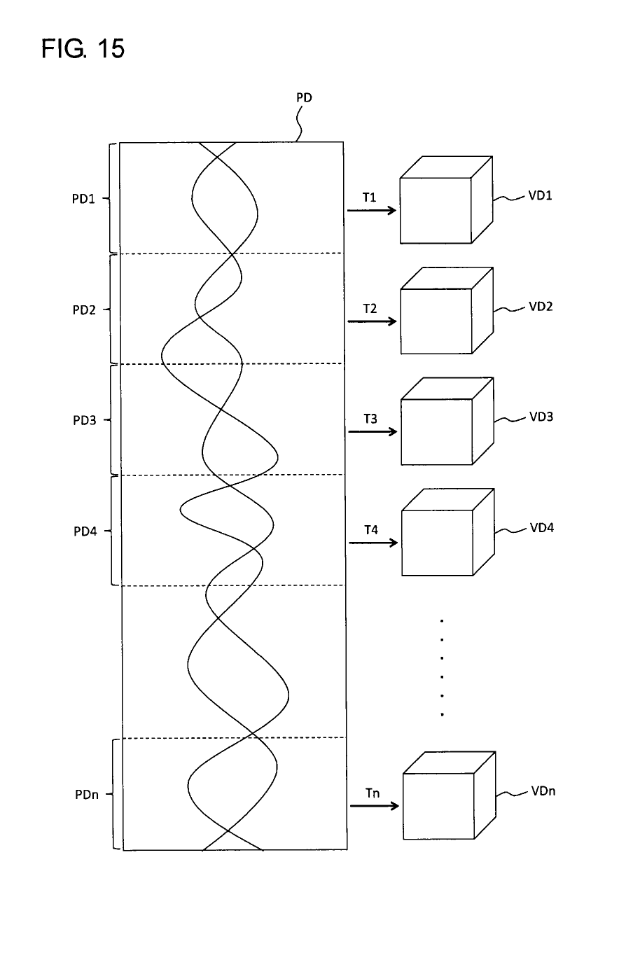

In the present embodiment, a 4D scan is implemented. An example of the projection data acquired by the 4D scan is depicted in FIG. 15. Projection data PD comprises multiple acquisition projection data PD1 to PDn, corresponding to multiple acquisition timings T1 to Tn. When imaging the heart, for example, it would comprise projection data corresponding to multiple cardiac time phases.

The reconstruction processor 432 subjects each projection data PDi (i=1 to n) to reconstruction processing. As a result of this, the reconstruction processor 432 forms volume data VDi corresponding to each acquisition timing Ti (see FIG. 15).

The following is a description of the display formats that make it possible to easily ascertain the temporal relationship and positional relationship between images based on multiple volume data VDi, which has been acquired as described above, and in which the acquisition timing is different.

### Displaying Operation Based on Acquisition Timing

The following is a description of the display format used in order to clarify the time temporal relationship between images based on multiple volume data with different acquisition timing in the first to the third operation examples. These operation examples have the following two points in common: (1) time series information indicating the multiple acquisition timing T1 to Tn from the continuous acquisition of data by the gantry apparatus 10 is displayed on the display 45; and (2) each acquisition timing Ti based on this time series information is presented.

The first operation example describes a case in which an image indicating temporal axis (temporal axis image) is applied as the time series information, and each acquisition timing Ti is presented using coordinates on this temporal axis image. The second operation example describes a case in which the information indicating the time phase of the internal organ (time phase information) is applied as the time series information, and each acquisition timing Ti is presented using the time phase information presentation format. The third operation example describes a case in which a contrast agent is used in imaging, information (contrast information) indicating the various timings (contrast timings) of the changes in a contrast state over time is used as the time series information, and each acquisition timing Ti is presented using the contrast information presentation format.

### First Operation Example

This operation example presents the acquisition timing Ti using a temporal axis image. The multiple acquisition timings Ti and multiple volume data VDi can be coordinated using the information indicating the acquisition timing, acquired from the information acquisition device 412. This coordination continues into the image (MPR image, and the like) formed from each piece of volume data VDi by the rendering processor 413.

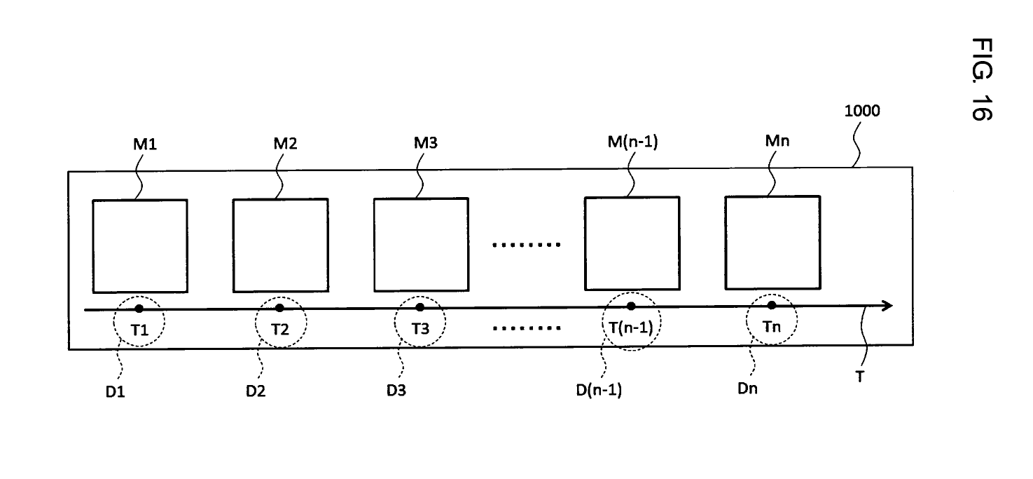

The display controller 411 causes the display 45 to display a screen 1000, based on this coordination, as depicted in FIG. 16. The screen 1000 presents a temporal axis image T. The temporal axis image T indicates the flow of time during which data is acquired by the gantry apparatus 10. Further, the display controller 411 causes the display of point images indicating the position of coordinates corresponding to each acquisition timing Ti on the temporal axis image T. Furthermore, the display controller 411 causes the display of the letters “Ti” indicating the acquisition timing in the lower vicinity of each point image. The combinations of these point images and the letters are equivalent to the information Di, which indicate acquisition timing.

In addition, the display controller 411 causes the display of an image Mi, obtained by rendering the volume data VDi, in the upper vicinity of each piece of information Di. The volume data VDi is based on the data acquired from the acquisition timing indicated in the information Di. This image may be a thumbnail. In this case, the display controller 411 processes to scale down each of the images acquired by rendering, to generate a thumbnail.

Using this display format makes it possible to ascertain the type of timing that data has been acquired from the information Di, which is a combination of point images and letters on the coordinates axis image T. Furthermore, from the correspondence relationship between the information Di and the image Mi, it is possible to ascertain at a glance the type of temporal relationship between the multiple images Mi.

In the example above, all the images corresponding to acquisition timing or thumbnails (referred to as “images, and the like”) are displayed in time order. It is, however, possible to display only some (one or more of the images, and the like) of these images, and the like. In this case, in response to that the user uses the operation part 46 to specify the position of coordinates on the coordinate axis image T, the display controller 411 may be configured to cause the selective display of the images, and the like, corresponding to the position of those coordinates based on the above correspondence.

### Second Operation Example

This operation example presents the various acquisition timings Ti based on the presentation format of the internal organ time phase information. The following is a description of the case in which the cardiac cyclical movement time phase is expressed by TP % (TP=0 to 100%). It is, however, possible to also cause the display of information (letters, images, and the like) indicating the time phase of the P waves, Q waves, R waves, S waves, U waves, and the like, in cardiac movement along with the image. Further, it is also possible to cause the display of information (letters, images, and the like) indicating time phases of exhalation (start, end), inhalation (start, end), resting, and the like in lung movement. Furthermore, it is also possible to cause the display of time phases using a temporal axis image, as in the first operation example. The coordination of each time phase and image is done using the information indicating acquisition timing acquired by the information acquisition device 412.

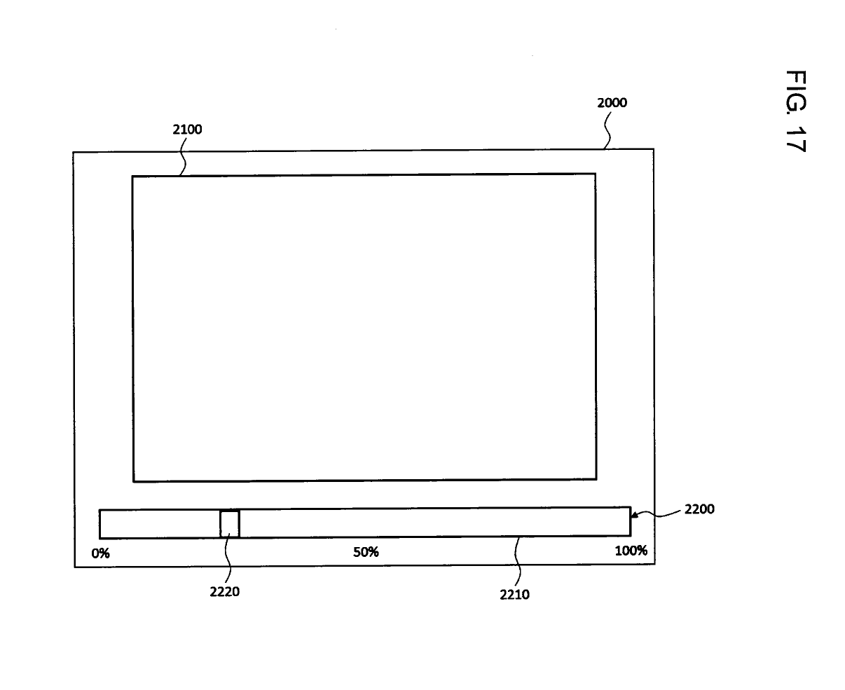

In this operation example, the display controller 411 causes the display of a screen 2000 as depicted in FIG. 17. The screen 2000 is provided with an image display 2100 and a time phase display 2200. The display controller 411 selectively displays images M1 to Mn, based on the multiple volume data VD1 to VDn on the image display 2100. These images M1 to Mn are specified as MPR images with the same cross-section position, or alternatively those images M1 to Mn are specified as pseudo three-dimensional images acquired by volume rendering from the same viewpoint.

The time phase display 2200 is provided with a timeframe bar 2210, which indicates the timeframe equivalent to a single cycle of cardiac movement. The timeframe bar 2210 is assigned longitudinally into time phases, from 0% to 100%. The inside of the timeframe bar 2210 is provided with a sliding part 2220, which can slide in the longitudinal direction of the timeframe bar 2210. The user can change the position of the sliding part 2220 using the operation part 46. This operation can be performed by, for example, dragging a mouse.

Moving the sliding part 2220 allows the display controller 411 to identify the acquisition timing (time phase) image Mi that corresponds to the position of the sliding part 2220 after the movement. Further, the display controller 411 causes the display of this image Mi on the image display 2100. In this way, it is possible to easily cause the display of the desired time phase image Mi. Furthermore, with reference to the position of the sliding part 2220 and the image Mi displayed on the image display 2100, it is possible to easily ascertain the correspondence relationship between the time phase and the image.

As another example of the display, the display controller 411 can cause the sequential switching display of multiple images Mi on the image display 2100 in time order, while at the same time synchronizing the switching of the display based on the correspondence relationship between the images and the time phase and causing the moving display of the sliding part 2220. In this case, the image display is a moving image display or a slide show display. Furthermore, it is possible to stop or restart the switching display in response to the operation of the operation part 46. Additionally, in accordance with the operation, it is possible to change the speed at which the display switches between images. Furthermore, in accordance with the operation, it is possible to cause the images to be switched in reverse time order. In addition, in accordance with the operation, it is possible to cause the display to jump to an arbitrary time phase image. Furthermore, in accordance with the operation, it is possible to cause the display of a limited, arbitrary partial timeframe between 0% and 100%. In addition, in accordance with the operation, it is possible to cause a repeated display. Using these display examples, it is possible to easily ascertain the correspondence relationship between the images Mi in the switching display and their time phases.

### Third Operation Example

This operation example presents the various acquisition timings Ti using a contrast information presentation format indicating the contrast timing. As contrast information presentation methods, for example, it is possible to present contrast information as coordinate positions on a temporal axis image, similarly to that in the first operation example. It is also possible to present contrast information using a timeframe bar and sliding part, similarly to that in the second operation example. Additionally, it is also possible to present contrast information using letters, images, and the like indicating the contrast timing. The following is a description of an example using a temporal axis image.

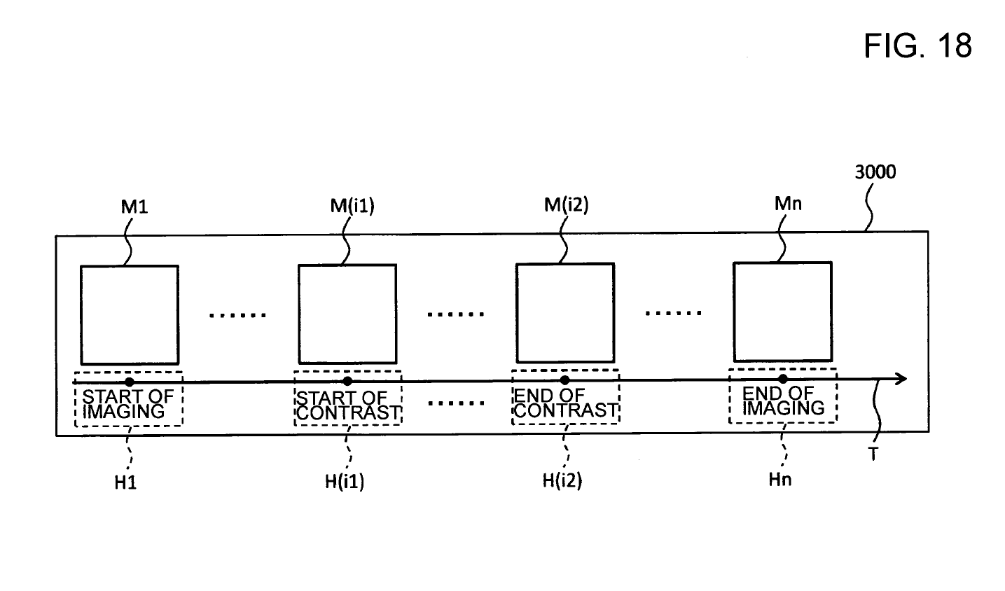

FIG. 18 depicts an example of a screen on which contrast information is presented using a temporal axis image. The temporal axis image T is presented on the screen 3000. The temporal axis image T indicates the flow of data acquisition time in an imaging process using a contrast agent. Additionally, the display controller 411 causes the display of point images indicating the position of coordinates corresponding to each contrast timing on the temporal axis image T. Furthermore, the display controller 411 causes the display of letters indicating the acquisition timing, including the contrast timing, in the lower vicinity of each point image. In this example, the letters indicating acquisition timing may be displayed as “start of imaging” “start of contrast,” “end of contrast” or “end of imaging.” The combination of point images and letters is equivalent to the information Hi, which indicates the acquisition timing (including contrast timing).

In addition, the display controller 411 causes the display of the image Mi, obtained by rendering the volume data VDi, in the upper vicinity of each piece of information Hi. The volume data VDi is based on the data acquired from the acquisition timing indicated in the information Hi. This image may be a thumbnail. In this case, the display controller 411 processes to scale down each of the images acquired by rendering, to generate a thumbnail.

Using this display format makes it possible to ascertain the type of timing, especially the type of contrast timing, in which the data has been acquired from the information Hi, which comprises a combination of point images and letters on the coordinates axis image T. Furthermore, from the correspondence relationship between the information Hi and the image Mi, it is possible to ascertain at a glance the type of temporal relationship between the multiple images Mi.

In the example above, all the images corresponding to acquisition timing or thumbnails (referred to as “images, and the like”) are displayed in time order. It is, however, possible to display only some (one or more of the images, and the like) of these images, and the like. In this case, in response to that the user uses the operation part 46 to specify the position of coordinates on the coordinate axis image T, the display controller 411 may be configured to cause the selective display of the images, and the like, corresponding to the position of those coordinates based on the above correspondence.

### Displaying Operation in Consideration of Positional Relationship Between Images

The following is a description of the display format taking into consideration the positional relationship and temporal relationship between images in the first to the fourth operation examples. In the first and second operation examples, a description is given of the case in which two or more images are displayed in which the FOV overlaps. In the third operation example, a description is given of the case in which the global image is used as a map expressing the distribution of FOV images (local images) contained therein. The global image is the image with the maximum FOV. In the fourth operation example, a description is given of the case in which the reconstruction conditions settings are displayed.

### First Operation Example

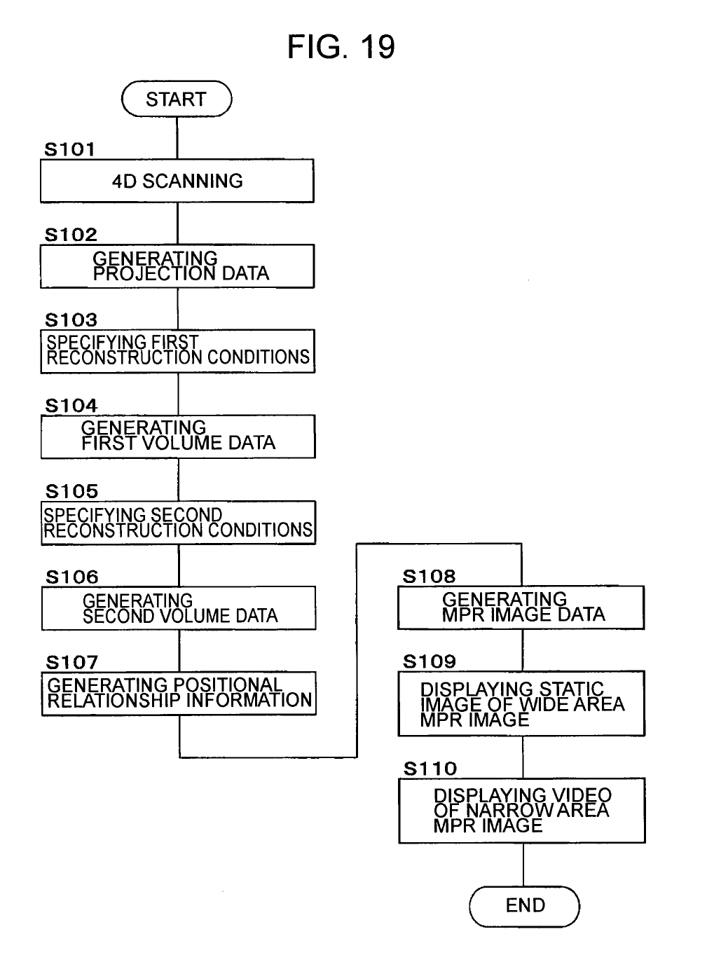

This operation example is one in which two or more images are displayed in which the FOV overlaps. Here, one of the images is a moving image. The individual moving image displays include a slide show display. If three or more images are displayed, the same process is carried out. In this case, statically displayed images and moving images are mixed together. The flow of this operation example is depicted in FIG. 19.

### (S101: 4D Scanning)

Firstly, the subject E is placed on the top of the coach apparatus 30, and inserted into the opening of the gantry apparatus 10. When the specified scan operation is begun, the controller 41 transmits a control signal to the scan controller 42. Upon receiving this control signal, the scan controller 42 controls the high-voltage generator 14, the gantry driver 15 and the collimator driver 17, and implements a 4D scan of the subject E. The X-ray detector 12 detects X-rays passing through the subject E. The data acquisition unit 18 acquires the successively generated detection data from the X-ray detector 12 in line with the scan. The data acquisition unit 18 transmits the acquired detection data to the pre-processor 431.

### (S102: Generating Projection Data)

The pre-processor 431 implements the aforementioned pre-processing on the detection data from the data acquisition unit 18, and generates projection data PD as depicted in FIG. 15. The projection data PD includes multiple projection data PD1 to PDn with different acquisition timings (time phases). Each piece of projection data PDi may be referred to as partial projection data.

### (S103: Specifying First Reconstruction Conditions)

First reconstruction conditions used to reconstruct the image based on the projection data PD are specified. This specification process includes specifying FOV. The specification of FOV can be implemented, for example, manually, with reference to the image based on the projection data. For the case in which a scanogram has been acquired separately, the user can specify the FOV with reference to the scanogram. Further, it is also possible to configure the specified FOV settings automatically. In this operation example, the FOV in the first reconstruction conditions is included in the FOV of the second reconstruction conditions, discussed below.

The first reconstruction conditions may be specified individually with regard to multiple pieces of partial projection data PDi. Alternatively, the same first reconstruction conditions may be specified with regard to all the partial projection data PDi. Additionally, the multiple pieces of partial projection data PDi may be divided into two or more groups, and the first reconstruction conditions may be specified for each group (this is also true for the second reconstruction conditions). The same scope of FOV must be set, however, for all the partial projection data PDi.

### (S104: Generating First Volume Data)

The reconstruction processor 432 implements reconstruction processing based on the first reconstruction conditions on the projection data PDi. As a result, the reconstruction processor 432 generates the first volume data. This reconstruction processing is implemented for each piece of partial projection data PDi. This results in the acquisition of multiple volume data VD1 to VDn, as depicted in FIG. 15.

### (S105: Specifying Second Reconstruction Conditions)

Next, second reconstruction conditions are specified in the same way as in step 3. This specification process also includes specifying the FOV. As noted above, the FOV here has a broader range than the FOV under the first reconstruction conditions.

### (S106: Generating Second Volume Data)

The reconstruction processor 432 implements reconstruction processing based on the second reconstruction conditions on the projection data PDi. As a result, the reconstruction processor 432 generates second volume data. This reconstruction processing is implemented on one of the multiple pieces of projection data PDi. The projection data subjected to this reconstruction processing is annotated by the symbol PDk.

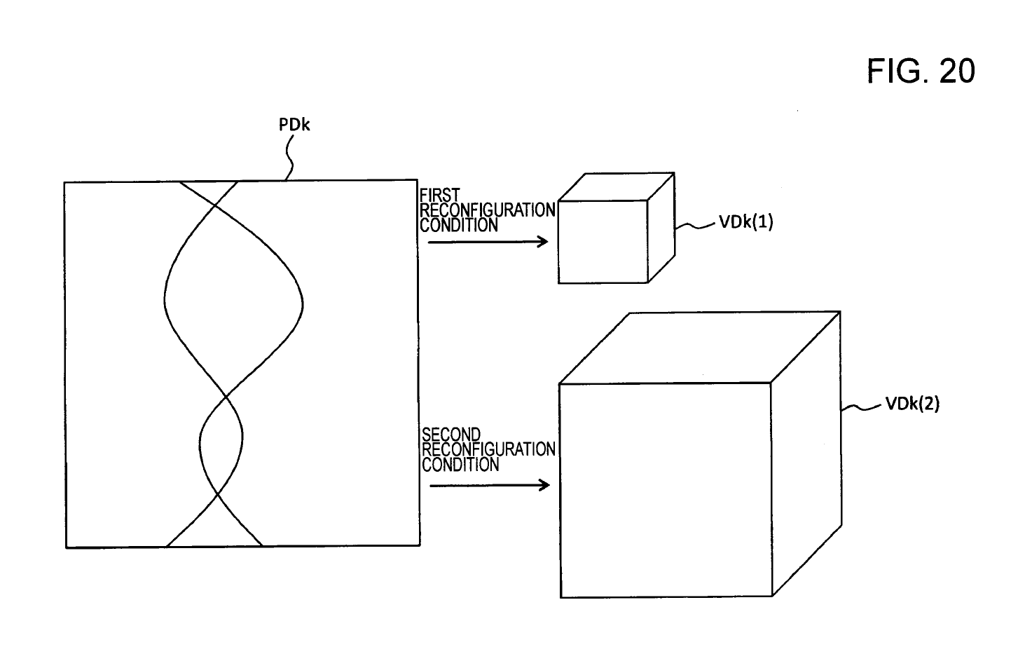

An outline of the two types of reconstruction processing to which the projection data PDk is subjected is depicted in FIG. 20. The projection data PDk is subjected to reconstruction processing based on the first reconstruction conditions. As a result, first volume data VDk (1), which has a comparatively small FOV, is acquired. Additionally, the projection data PDk is subjected to reconstruction processing based on the second reconstruction conditions. As a result, second volume data VDk (2), which has a comparatively large FOV, is acquired.

The FOV of the first volume data VDk (1) and the FOV of the second volume data VDk (2) overlap. In the operation example, as described above, the FOV of the first volume data VDk (1) is included within the FOV of the second volume data VDk (2). Such the settings, for example, may be used when the image based on the second volume data VDk (2) is used to view a wide area, while the image based on the first volume data VDk (1) is used to focus on certain points (internal organs, diseased areas, or the like.)

The selection of projection data PDk is arbitrary. The user may, for example, select the projection data PDk for the desired time phase manually. Additionally, the system can be configured such that the projection data PDk is selected automatically by the controller 411. The specified projection data PDk may be defined as the first projection data PD1, for example. Alternatively, it is also possible to select the projection data PDk for a specified acquisition timing (time phase) based on the information indicating the acquisition timing acquired by the information acquisition device 412.

### (S107: Generating Positional Relationship Information)

The positional relationship information generating unit 434 acquires positional information for the volume data at the specified FOV, based on either the projection data or the scanogram. Thereby, the positional relationship information generating unit 434 generates positional relationship information by coordinating the two pieces of acquired positional information.

### (S108: Generating MPR Image Data)

The rendering processor 433 generates MPR image data based on the wide area volume data VDk (2), generated based on the second reconstruction conditions. This MPR image data is defined as wide area MPR image data. This wide area MPR image data may be one of the pieces of orthogonal three-axis image data, or it may be an oblique image data based on an arbitrarily specified cross-section. Hereinafter, images based on the wide area MPR image data may be referred to as “wide area MPR images.”

Furthermore, the rendering processor 433 generates MPR image data based on each of the narrow area volume data VD1 to VDn, generated based on the first reconstruction conditions at the same cross-section as the wide area MPR image data. This MPR image data is defined as narrow area MPR image data. Hereinafter, images based on the narrow area MPR image data may be referred to as “narrow area MPR images.”

As a result of this MPR processing, at the same cross-section, single wide area MPR image data and multiple narrow area MPR image data with different acquisition timings are acquired.

### (S109: Displaying Static Image of Wide Area MPR Image)

The controller 41 causes the display 45 to display a wide area MPR image. The wide area MPR image is displayed as a static image.

### (S110: Displaying Video of Narrow Area MPR Image)

The display controller 41 determines the display position of a narrow area MPR image within the wide area MPR image, based on the positional relationship information acquired in step 107. Furthermore, the display controller 411 causes the sequential switching display of multiple narrow area MPR images in time order based on multiple narrow area MPR image data. In other words, video display is implemented based on the narrow area MPR images.

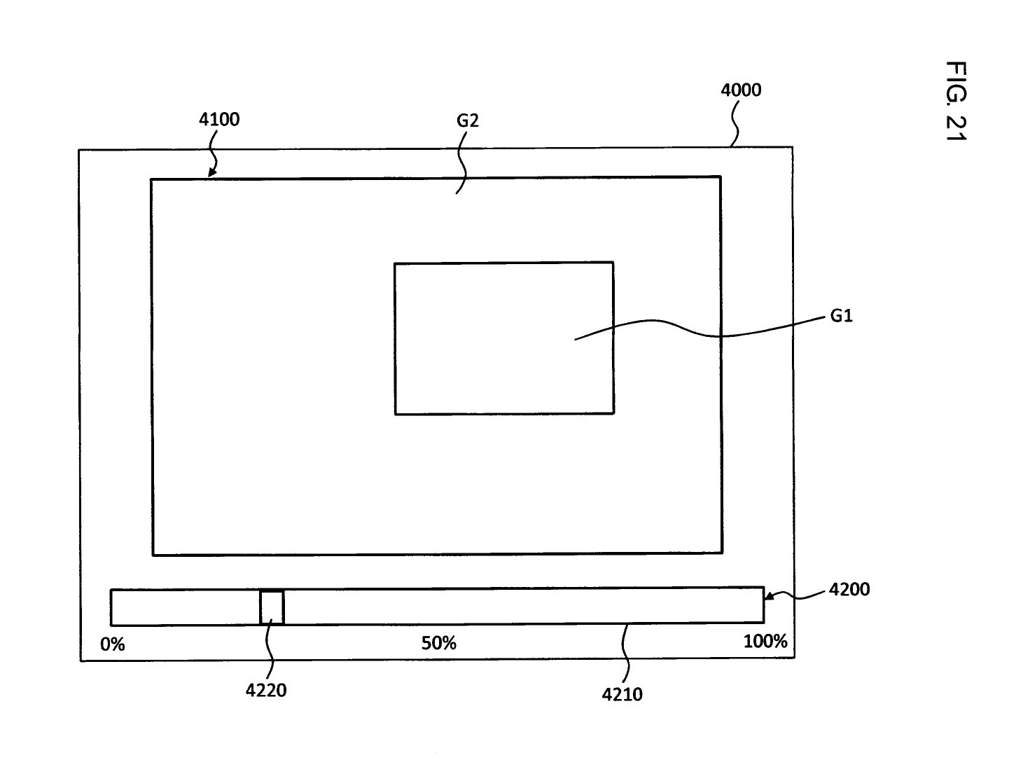

FIG. 21 depicts an example of the display format realized by steps 109 and 110. A screen 4000 in FIG. 21 is provided, as shown on the screen 2000 in FIG. 17, with an image display 4100 and a time phase display 4200. The time phase display 4200 is also provided with a timeframe bar 4210 and a sliding part 4220. The display controller 411 causes not only the wide area MPR image G2 to be displayed on the image display 4100, but also the moving image G1 based on multiple narrow area MPR images to be displayed in the area within the wide area MPR image based on positional relationship information.

The display controller 411 moves the sliding part 4220 synchronized with the switching display of the multiple narrow area MPR images, in order to display a moving image. Additionally, the display controller 411 implements display control as noted above in response to the operation of the sliding part 4220.

According this operation example, it is possible to use the moving image based on the narrow area MPR image to observe the changes in the state of the focused area over time, while ascertaining the state of the surrounding area from the wide area MPR image G2.

### Second Operation Example

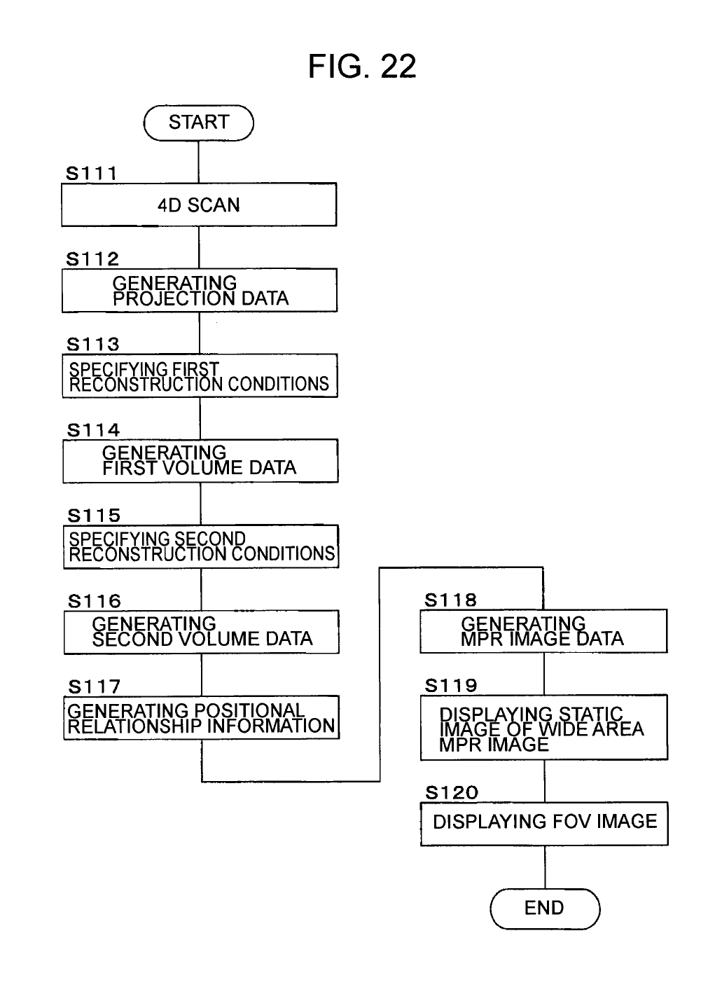

Similar to the first operation example, this operation example involves the display of two or more images with overlapping FOV. Here, the description concerns a case in which two images with different FOV are displayed. In cases where three or more images are displayed, the same process is implemented. FIG. 22 depicts the flow of this operation example.

### (S111: 4D Scan)

Firstly, a 4D scan is implemented as in the first operation example.

### (S112: Generating Projection Data)

The pre-processor 431 implements the aforementioned pre-processing on the detection data from the data acquisition unit 18 as in the first operation example. As a result, the pre-processor 431 generates the projection data PD, including multiple partial projection data PD1 to PDn.

### (S113: Specifying First Reconstruction Conditions)

First reconstruction conditions used to reconstruct the image are specified based on the projection data PD, as in the first operation example. This specification process includes specifying the FOV.

### (S114: Generating First Volume Data)

The reconstruction processor 432 implements reconstruction processing based on the first reconstruction conditions on the projection data PDi, as in the first operation example. As a result, the reconstruction processor 432 generates first volume data. This results in the acquisition of multiple volume data VD1 to VDn.

### (S115: Specifying Second Reconstruction Conditions)

Second reconstruction conditions are specified in the same way as in the first operation example. This specification process also includes specifying the FOV. The FOV here has a broader range than the FOV in the first reconstruction conditions.

### (S116: Generating Second Volume Data)

As in the first operation example, the reconstruction processor 432 implements reconstruction processing based on the second reconstruction conditions on the single piece of projection data PDk. As a result, the reconstruction processor 432 generates second volume data.

### (S117: Generating Positional Relationship Information)

The positional relationship information generating unit 434 generates positional relationship information as in the first operation example.

### (S118: Generating MPR Image Data)

The rendering processor 433 generates wide area MPR image data and narrow area MPR image as in the first operation example. As a result, a single piece of wide area MPR image data and multiple narrow area MPR image data with different acquisition timing are acquired, at the same cross-section.

### (S119: Displaying Static Image of Wide Area MPR Image)

The display controller 411 causes the display 45 to display a wide area MPR image based on the wide area MPR image data. The wide area MPR image is displayed as a static image.

### (S120: Displaying FOV Image)

Further, the display controller 411 causes the display of the FOV image, which expresses the position of the narrow area MPR image within the wide area MPR image based on the positional relationship information generated in step 117, overlapping the wide area MPR image. The user may also display the FOV image corresponding to the specified operation implemented by using the operation part 46. Furthermore, in response to the specific operation, while the wide area MPR image is being displayed, the FOV image may also be simultaneously displayed.

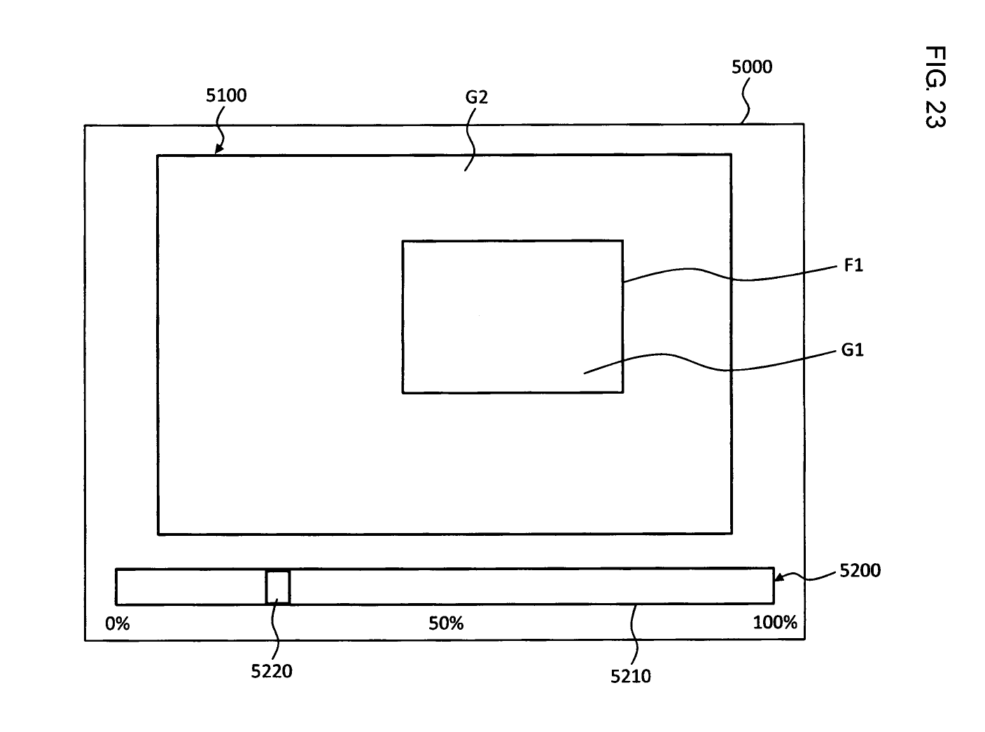

FIG. 23 depicts a display example of the FOV image. A screen 5000 is provided, as is the screen 2000 in FIG. 17, with an image display 5100 and a time phase display 5200. The time phase display 5200 is also provided with a timeframe bar 5210 and a sliding part 5220. The display controller 411 causes not only the wide area MPR image G2 to be displayed on the image display 5100, but also the FOV image F1 to be displayed in the area within the wide area MPR image, based on positional relationship information.

When the user specifies the position of the sliding part 5220 using the operation part 46, the display controller 411 causes the display of the narrow area MPR image G1 corresponding to the specified position within the FOV image F1. Furthermore, when the specified operation is performed, the display controller 411 causes not only the moving image G2 based on the multiple narrow area MPR images to be displayed in the FOV image F1, but also the sliding part 4220 in synchronization with the switching display of the multiple narrow area MPR images to be moved. Additionally, the display controller 411 implements display control as noted above in response to the operation with respect to the sliding part 4220.

According to the display example, it is possible to ascertain the positional relationship between the wide area MPR image and the narrow area MPR image from the FOV image. Furthermore, displaying a narrow area MPR image of the desired acquisition timing (time phase) makes it possible to ascertain the state of the focused area and the state of the surrounding area at the acquisition timing. Additionally, it is possible to use the moving image based on the narrow area MPR image to observe the changes in the state of the focused area over time, while ascertaining the state of the surrounding area from the wide area MPR image G2.

The following is a description of another example. The user uses the operation part 46 to specify the FOV image F1. This specification operation can be done, for example, by clicking the FOV image F1 with a mouse. In this operation example, only one FOV image is displayed. The same process is carried out, however, for cases in which two or more FOV images are to be displayed.

When the FOV image F1 is specified, the display controller 411 causes the display 45 to display the narrow area MPR image corresponding to the FOV image F1. The display format may be any one of the following: (1) a display switching between the wide area MPR image G2 and the narrow area MPR image G1, as in FIG. 5A; (2) a parallel display of the wide area MPR image G2 and the narrow area MPR image G1, as in FIG. 5B; or (3) a superimposed display in which the narrow area MPR image G1 is superimposed on the wide area MPR image G2, as in FIG. 5C.

The display format of the narrow area MPR image G1 may be either a static or a moving image display. If it is a moving image display, it is possible to present changes in the time phase (acquisition timing) in the moving image display using the aforementioned timeframe bar, sliding part, and the like. If the display is static, it is possible to selectively display the narrow area MPR image for the time phase specified using the sliding part, and the like. Furthermore, using a parallel display, it is possible either to display the FOV image F1 inside the wide area MPR image G2, or not to display the image at all. Additionally, when displaying a superimposed image, the narrow area image G1 is displayed in the FOV image F1 position, based on the positional relationship information.

The display format implemented may be preset in advance, or may be selected by the user. In the latter case, it is possible to switch between display formats in response to the operation implemented using the operation part 46. For example, in response to right-clicking the FOV image F1, the display controller 411 causes the display of a pull-down menu displaying the aforementioned three display formats. If the user clicks the desired display format, the display controller 411 implements the selected display format.

According the display example, the smooth transition, at the desired timing, from observation of the wide area MPR image G1 to the narrow area MPR image G1 can be performed. Further, according to a parallel display, a work for comparing two images can be done easily. Additionally, displaying the FOV image F1 inside the wide area MPR image G2 makes it simple to ascertain the positional relationship between the two images in the parallel display. Furthermore, according to a superimposed display, it can be easy to ascertain the positional relationship between the two images. Additionally, presenting time phase changes in the superimposed display makes it possible to easily ascertain the changes over time in the state of the focused area, as well as the state of the surrounding area.

### Third Operation Example

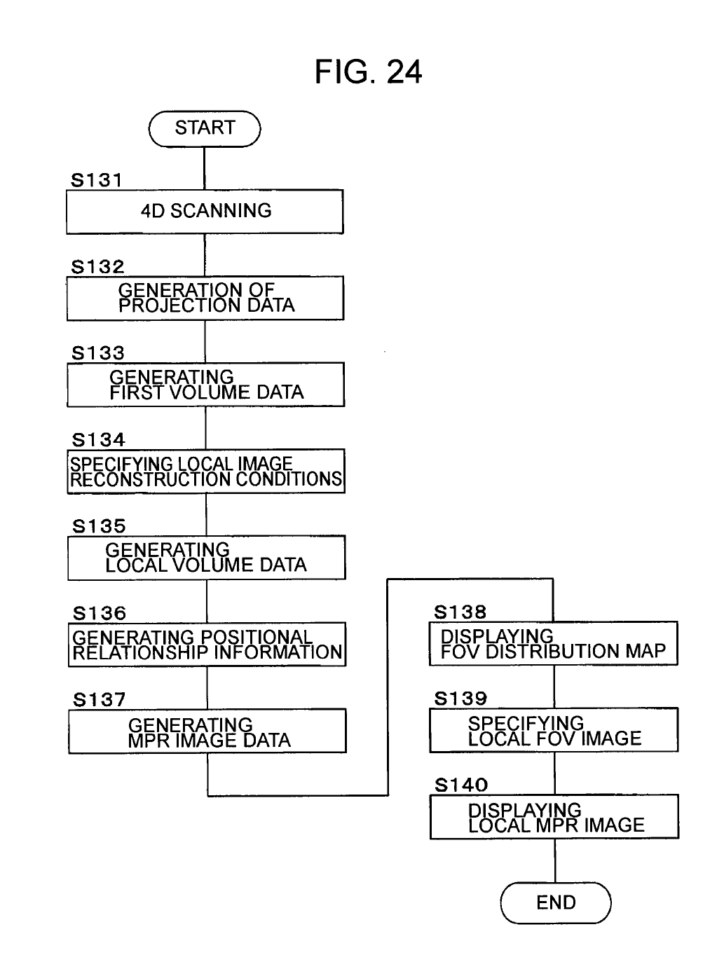

This operation example uses the global image as a map expressing the distribution of local images. Here, a description is given of a case expressing the distribution of two local images with different FOV. The same process is implemented when three or more local images are to be displayed. FIG. 24 depicts the flow of this operation example.

### (S131: 4D Scanning)

A 4D scan is implemented as in the first operation example.

### (S132: Generation of Projection Data)

The pre-processor 431 implements the aforementioned pre-processing on detection data from the data acquisition unit 18 as in the first operation example. As a result, the pre-processor 431 generates projection data PD, including multiple partial projection data PD1 to PDn.

### (S133: Generating Gloval Volume Data)

The reconstruction processor 432 reconstructs the projection data PDi based on reconstruction conditions, to which the maximum FOV has been applied as an FOV condition item. As a result, the reconstruction processor 432 generates the maximum FOV volume data (global volume data). This reconstruction processing is implemented with regard to one piece of projection data PDk.

### (S134: Specifying Local Image Reconstruction Conditions)

The local image reconstruction conditions are specified in the same way as in the first operation example. The FOV in these reconstruction conditions is a partial area of the maximum FOV. Here, first local image reconstruction conditions and second local image reconstruction conditions are specified, respectively.

### (S135: Generating Local Volume Data)

The reconstruction processor 432 implements reconstruction processing on each of the projection data PDi based on the first local image reconstruction conditions. Thereby, the reconstruction processor 432 generates first local volume data. Further, the reconstruction processor 432 implements reconstruction processing on each of the projection data PDi based on the second local image reconstruction conditions. Thereby, the reconstruction processor 432 generates second local volume data. The first and second local volume data include multiple volume data corresponding to the multiple acquisition timings (time phases) T1 to Tn.

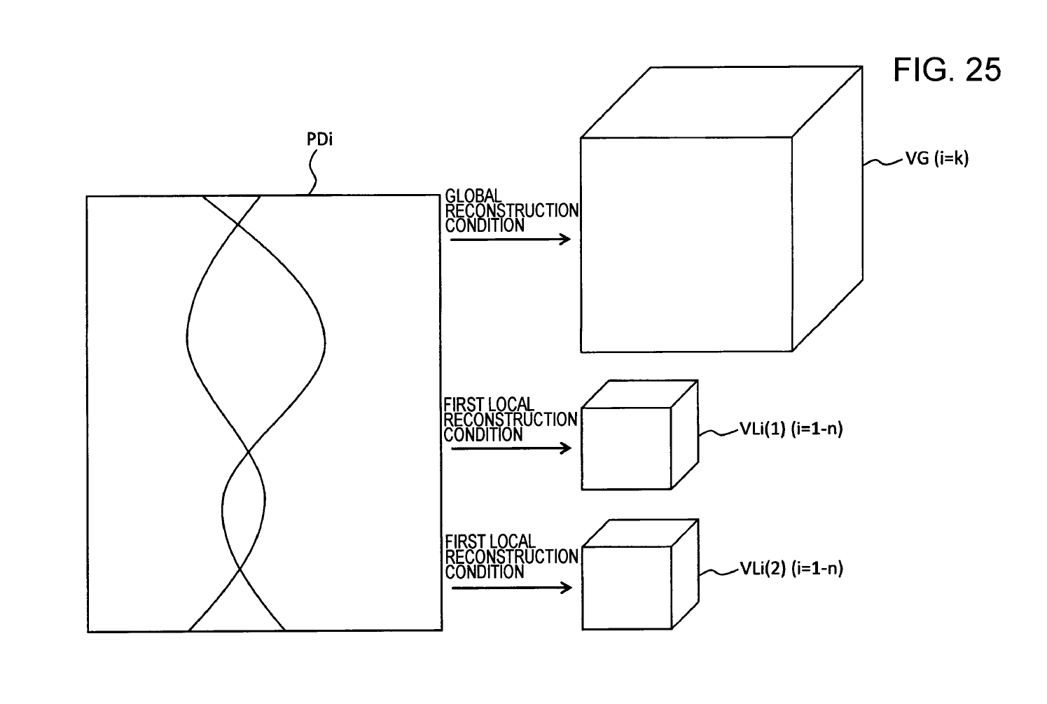

FIG. 25 depicts an outline of the processes from steps 133 to 135. As depicted in FIG. 25, three pieces of volume data (global volume data VG, and local volume data VLk (1) and VLk (2)) are acquired with regard to the partial projection data PDk (i=k) corresponding to the acquisition timing Tk. The global volume data VG is acquired from reconstruction processing based on the maximum FOV reconstruction conditions (global reconstruction conditions). The local volume data VLk (1) and VLk (2) are acquired from reconstruction processing based on the local FOV reconstruction conditions (local reconstruction conditions) included in the maximum FOV. On the other hand, global volume data is not generated for the partial projection data PDi (i≠k), which corresponds to the various acquisition timings Ti other than the acquisition timing Tk, and two sets of local volume data VLi (1) and VLi (2) are acquired. As a result, one global volume data VG, n local volume data VLi (1) (i=1 to n) and n local volume data VLi (2) (i=1 to n) are acquired.

### (S136: Generating Positional Relationship Information)

The positional relationship information generating unit 434 acquires positional information with regard to volume data VG, VLi (1) and VLi (2) about each of the specified FOV, based on the projection data, or on the scanogram. The positional relationship information generating unit 434 also generates positional relationship information, by coordinating the three pieces of acquired positional information.

### (S137: Generating MPR Image Data)

The rendering processor 433 generates MPR image data (global MPR image data) based on the global volume data VG. This global MPR image data may be any one of the orthogonal three-axis image, or it may be an oblique image data based on an arbitrarily specified cross-section.

Further, the rendering processor 433 generates MPR image data (first local MPR image data) with regard to the cross-section that is the same as the global MPR image data, based on each local volume data VLi (1). Additionally, the rendering processor 433 generates MPR image data (second local MPR image data) with regard to the cross-section that is the same as the global MPR image data, based on each local volume data VLi (2).

This MPR processing allows the acquisition of one piece of global MPR image data, and n first local MPR image data, corresponding to the acquisition timing T1 to Tn. Further, n second local MPR image data, corresponding to the acquisition timing T1 to Tn, are also acquired. The n first local MPR image data expresses the same cross-section, and the n second local MPR image data also expresses the same cross-section. The cross-section of this local MPR image data is included in the cross section of the global MPR image data.

### (S138: Displaying FOV Distribution Map)

The display controller 411 causes the display 45 to display a map (FOV distribution map) expressing the distribution of local FOV in the global MPR image, based on the positional relationship information generated in step 136. The global MPR image is the MPR image based on the global MPR image data.

An example of the FOV distribution map is depicted in FIG. 8. A first local FOV image FL1 in FIG. 8 is an FOV image expressing the scope of the first local MPR image data. Further, a second local FOV image FL2 is an FOV image expressing the scope of the second local MPR image data. The FOV distribution map depicted in FIG. 8 is a map displaying that the first local FOV image FL1 and the second local FOV image FL2 are superimposed on a global MPR image GG. Here, the user may also display either of the local FOV images FL1 or FL2 in response to a specified operation using the operation part 46. Furthermore, during the time that the global MPR image GG is displayed in response to the specified operation, the local FOV images FL1 and FL2 may also be displayed.

### (S139: Specifying Local FOV Image)

The user specifies the local FOV image that corresponds to the local MPR image in order to display the desired local MPR image using the operation part 46. This specification operation is done, for example, by clicking the local FOV image using a mouse.

### (S140: Displaying Local MPR Image)

When the local FOV image is specified, the display controller 411 causes the display 45 to display the local MPR image corresponding to the specified local FOV image. The display format at this point may be either a static or a moving image display of the local MPR image. If it is a moving image display, it is possible to present changes in the time phase (acquisition timing) in the moving image display using the aforementioned timeframe bar, sliding part, and the like. If the display is static, it is possible to selectively display the narrow area MPR image for the time phase specified using the sliding part, and the like.

Furthermore, the local MPR image display format may be a switching display, a parallel display or a superimposed display, as in the second operation example. By specifying two or more FOV images, it is also possible to line up two or more local MPR images in parallel for observation.

According to the operation example, it is possible to easily ascertain the distribution of local MPR images with various FOV using the FOV distribution map. In addition, presenting the distribution of local MPR images on the global MPR image corresponding to maximum FOV makes it possible to ascertain the distribution of local MPR images within the scan range. Furthermore, specifying the desired FOV within the FOV distribution map allows display of the local MPR image within the FOV, simplifying the image browsing operation.

### Fourth Operation Example

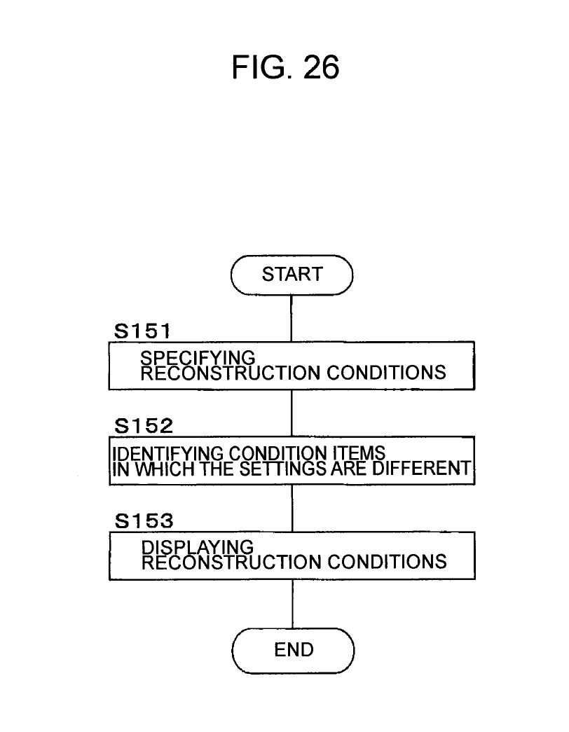

In this operation example, the reconstruction conditions settings are displayed. Here, a description is given of cases wherein settings in which the condition items are the same and settings in which the condition items are different for two or more reconstruction conditions are displayed in different formats. This operation example can be added to any one of the first to the third operation examples. Furthermore, this operation example may be applied to any arbitrary operation other than these. FIG. 26 depicts the flow of this operation example. This operation example is described for the case in which there are two specified reconstruction conditions. However, it is also possible to implement the same process for the case in which three or more reconstruction conditions are specified. The following description includes steps that are duplicated from the first to the third operation examples.

### (S151: Specifying Reconstruction Conditions)

The first reconstruction conditions and the second reconstruction conditions are specified. Condition items for each set of reconstruction conditions include the FOV and the reconstruction functions. As an example, in the first reconstruction conditions, the FOV is the maximum FOV, and the reconstruction functions are defined as pulmonary functions. In the second reconstruction conditions, the FOV is the local FOV, and the reconstruction functions are defined as pulmonary functions.

(S152: Identifying Condition Items in which the Settings are Different)

The controller 41 identifies condition items in which the settings are different between the first reconstruction conditions and the second reconstruction functions. In this operation example, the FOV is different but the reconstruction functions are the same, so the FOV is identified as the condition item in which the settings are different.

### (S153: Displaying Reconstruction Conditions)

The display controller 411 causes the condition items identified in step 152 and the other condition items to be displayed in different formats. The display process is implemented at the same time as the display processing of the various screens, as described above.

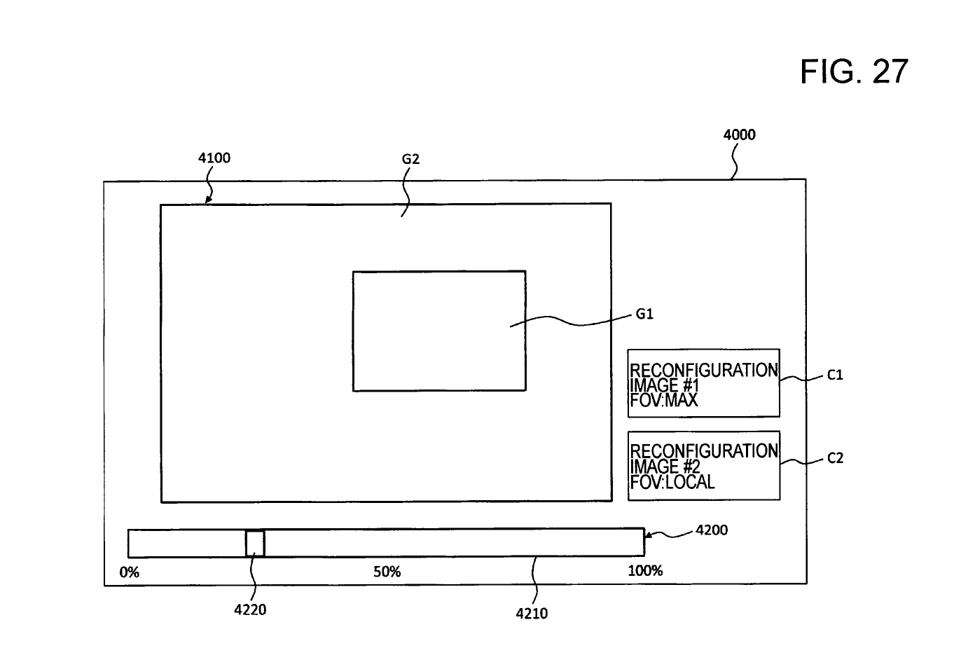

FIG. 27 depicts an example of the display of reconstruction conditions for the case in which this operation example is applied to the first operation example. The display 45 displays the screen 4000 as in FIG. 21 in the first operation example. The parts that are the same as FIG. 21 are indicated using the same numerals. The right hand side of image display 4100 on screen 4000 in FIG. 27 is provided with a first conditions display area C1 and a second conditions display area C2. The display controller 411 causes the display of the first reconstruction conditions settings corresponding to the (moving image of the) narrow area MPR image G1 in the first conditions display area C1. In addition, display controller 411 causes the display of the second reconstruction conditions settings corresponding to the wide area MPR image G2 in the second conditions display area C2.

In this operation example, the FOV settings are different and the reconstruction function settings are the same. As a result, the FOV settings and the reconstruction function settings are presented in different formats. In FIG. 27, the FOV settings are presented in bold and underlined, and the reconstruction function settings are presented in standard type with no underline. The display formats are not restricted to these two types. For example, different settings may be displayed using shading, by changing the color, or using any arbitrary display format.

### Operation/Benefits

The following is a description of operation and benefits of the X-ray CT apparatus 1 in the second embodiment.

The X-ray CT apparatus 1 comprises an acquisition unit (the gantry apparatus 10), an acquisition part (the information acquisition device 412), an image formation unit (the pre-processor 431, the reconstruction processor 432 and the rendering processor 433), a generating unit (the positional relationship information generating unit 434), a display (the display 45) and a controller (the display controller 411).

The acquisition unit scans a predetermined area of the subject E repeatedly with X-rays and acquires data continuously. This data acquisition is, for example, a 4D scan.

The acquisition part acquires a plurality of information indicating the acquisition timing of the continuously acquired data.

The image formation unit reconstructs first data, acquired during a first acquisition timing from the continuously acquired data, according to first reconstruction conditions, and forms a first image. The image formation unit also reconstructs second data, acquired during a second acquisition timing from the continuously acquired data, according to second reconstruction conditions, and forms a second image.

The generating unit generates positional relationship information expressing the positional relationship between the first image and the second image based on the continuously acquired data.

The controller causes the display to display the first image and the second image, based on the positional relationship information generated by the generating unit, and the information indicating the first acquisition timing and the information indicating the second acquisition timing acquired by the acquisition part.

Using this type of X-ray CT apparatus 1 makes it possible to reflect the positional relationship based on positional relationship information, and the temporal relationship based on information indicating acquisition timing, facilitating the display of images acquired based on multiple volume data with different acquisition timings. As a result, the user is able to easily ascertain the relationship between images, based on the multiple volume data with different acquisition timings.

The controller may be configured to cause the display of time series information indicating the multiple acquisition timings for data continuously acquired by the acquisition unit, and to present the first acquisition timing and the second acquisition timing respectively based on time series information. As a result, the user is able to ascertain the data acquisition timing in a time series manner. This makes it possible to easily ascertain the temporal relationship between images.

A temporal axis image indicating a temporal axis may be used as the time series information. In this case, the controller presents the position of coordinates corresponding to the first acquisition timing and the second acquisition timing on the temporal axis image. This makes it possible to ascertain the data acquisition on a temporal axis. Furthermore, it is possible to easily ascertain the temporal relationship between images from the relationship between the positions of sets of coordinates.

The time phase information, indicating the time phase of the movement of internal organs that are the subject of the scan, can be used as time series information. In this case, the controller presents time phase information indicating the time phase corresponding to each of the first acquisition timing and the second acquisition timing. As a result, the data acquisition timing can be grasped as the time phase of the movement of the organ, making it possible to easily ascertain the temporal relationship between images.

For cases in which a contrast agent is administered to the subject before scanning, it is possible to display contrast information indicating the contrast timing as time series information. In this case, the controller presents the contrast information indicating the contrast timing corresponding to each of the first acquisition timing and the second acquisition timing. As a result, the data acquisition timing when taking images using a contrast agent can be grasped as the contrast timing, making it possible to easily ascertain the temporal relationship between images.

If the acquisition timing indicated in the time series information is specified using the operation part (operation part 46), it is possible for the controller to cause the display to display an image (or thumbnail), based on the acquired data at the specified acquisition timing. As a result, it is easy to refer to the image at the desired acquisition timing.

For the case in which the first reconstruction conditions and the second reconstruction conditions include an overlapping FOV as a condition item, the following configuration can be applied: the image formation unit forms multiple images in line with the time series as the first image; and the controller, based on the mutually overlapping FOV, causes the display of a moving image, based on the multiple images, superimposed on the second image. As a result, it is possible to view a moving image indicating the changes over time in the state of a given FOV (particularly the focused area), while it is possible to observe the state of other FOVs as the static image.

In addition, the controller can synchronize switching display between multiple images in order to display a moving image, and cause the switching display of information indicating the multiple acquisition timings corresponding to the multiple images. This makes it possible to easily ascertain the correspondence of the transition in the acquisition timing and the transition in the moving images.

For cases in which the first reconstruction conditions and the second reconstruction conditions include a mutually overlapping FOV as a condition item, the controller causes the FOV image, which expresses the FOV in place of the first image, to be superimposed on the second image and displayed. As a result, the positional relationship between the first image and the second image can be easily ascertained.

Furthermore, when the FOV image is specified using the operation part, the controller can cause the display to display the first image. As a result, the first image can be browsed at the desired timing.

In addition, when the FOV image is specified using the operation part, the controller can implement any of the following display controls: switching display from the second image to the first image; parallel display of the first image and the second image; and superimposed display of the first image and the second image. Thereby, both images can be browsed as preferred.

The FOV image may be displayed at all times, but it is also possible to configure the system such that the FOV image is displayed in response to user demand. In this case, the controller is configured to display the FOV image superimposed on the second image in response to the operation (clicking, or the like) of the operation part when the second image is displayed on the display. In this way, it is possible to display the FOV image only when the user wishes to confirm the first image position, or to browse the image. Therefore, the FOV image does not become an obstruction to browse the second image.

The maximum FOV image may be used as a map indicating the distribution of local images. As an example of this configuration, the image formation unit forms a third image by reconstructing using the third reconstruction conditions, which include the maximum FOV as part of the FOV condition item settings. Next, the controller 41 causes the display of the FOV image of the first image and the FOV image of the second image superimposed on the third image. Displaying this type of FOV distribution map allows the user to easily ascertain the way in which the images acquired using the arbitrary reconstruction conditions are distributed within the maximum FOV. Even if this configuration is applied, it is possible to configure the system such that the FOV image is displayed only when required by the user. It is also possible to configure the system such that when the user specifies one of the FOV images displayed on the third image, a CT image corresponding to the specified FOV image is displayed.

It is possible to cause the display not only of settings related to FOV, but also of arbitrary reconstruction conditions. In this case, when the settings of different reconstruction conditions feature different condition items, it is possible to display these condition item settings in a different format to the other condition item settings. As a result, it is easy for the user to be aware of whether the settings are the same or different.

It is possible to display the FOV used in diagnosis as a list. This example is not one in which a given CT image (the third image) is displayed with the FOV image of a different CT image thereon, as above, but rather in which all or some of the FOV used in diagnosis are displayed as a list. For this reason, the following can be given as a configuration example. Both the first reconstruction conditions and the second reconstruction conditions include FOV as a condition item. The controller 41 causes the display 45 to display the FOV list information including the FOV information expressing the first image FOV and the FOV information expressing the second image FOV. As a result, it is possible to easily ascertain in what way the FOV being used in diagnosis are distributed. In this case, simulated images (contour images) of each of the internal organs are displayed along with the FOV images, making it possible to facilitate awareness of the (rough) positions of each FOV. Furthermore, if the user uses the operation part 46 to specify FOV information, the controller 41 can be configured to cause the display 45 to display the CT image corresponding to the specified FOV. Each piece of FOV information is displayed, for example, within a display area equivalent to the size of the maximum FOV.

If some of the FOV used in the diagnosis are to be displayed as a list, it is possible to categorize the FOV, for example, by internal organ, and selectively display only the FOV related to the specified internal organ. As a specific example of this, it is possible to categorize all FOV used in diagnosis of the chest into an FOV group related to the lungs and an FOV group related to the heart, and then selectively (exclusively) display each group in response to instructions from the user, and the like. It is also possible to categorize the FOV to correspond with reconstruction condition settings not related to FOV, and then selectively display only the FOV of the specified settings. As a specific example of this, it is possible to categorize all the FOV in the condition item “reconstruction functions” into a “pulmonary functions” FOV group and a “mediastinum functions” FOV group, and selectively (exclusively) display each group in response to instructions from the user, and the like.

### <Application to X-Ray Image Acquisition Apparatus>

The first embodiment and second embodiment above can be applied to an X-ray image acquisition apparatus.

The X-ray image acquisition apparatus has an X-ray photography device. The X-ray photography device acquires volume data by, for example, the high-speed rotation of a C-shaped arm, like a propeller, using a motor on a frame. In other words, the controller rotates the arm at high speeds at a angle of, for example, 50 degrees per second, like a propeller. At the same time, the X-ray photography device generates a high voltage to be supplied to an X-ray tube by a high-voltage generator. Furthermore, at this time, the controller controls an irradiation field of X-rays from an X-ray collimator. As a result, the X-ray photographic device captures images at, for example, two-degree intervals, and the X-ray detector acquires, for example, two-dimensional projection data of 100 frames.

The acquired 2D projection data is A/D converted by an A/D converter in the image processor, and stored in a two-dimensional image memory.

Next, the reconstruction processor implements reverse projection calculation to acquire volume data (reconstructed data). Here, a reconstructed area is defined as a cone inscribed by the X-ray beams in all directions from the X-ray tube. The inside of this cone may be, for example, three-dimensionally discretized at length d in the center of the reconstructed area projected at the width of one detection element of the X-ray detector, making it necessary to acquire the discrete point data reconstruction image. This indicates one example of a discrete interval, but the discrete interval defined by the individual apparatus may be used. The reconstruction processor stores the volume data in a three-dimensional image memory.

Reconstruction processing is implemented based on preset reconstruction conditions. The reconstruction conditions include various items (sometimes referred to as condition items). The condition items are as stated in the first embodiment and second embodiment above.

### Operation Example

Next, a description is given of an operation example of the X-ray image acquisition apparatus in the present embodiment. Here, the description concerns a case in which the first operation example and second operation example of the first embodiment are applied to the X-ray image acquisition apparatus. The third operation example and fourth operation example of the first embodiment may also, however, be applied to the aforementioned X-ray image acquisition apparatus. Furthermore, each of the operation examples [display operation based on acquisition timing] in the second embodiment may also be applied. Additionally, each of the operation examples [display operation in consideration of positional relationship between images] in the second embodiment may also be applied.

### First Operation Example

In this operation example, two or more images with overlapping irradiation fields are displayed. The following description deals with a case in which two or more images with different irradiation fields are displayed. For cases in which three or more images are displayed, the same process is implemented. The X-ray image acquisition apparatus acquires projection data as described above using the X-ray photography device. Here, first reconstruction conditions used to reconstruct the image based on the projection data are specified. This specification process includes specifying the irradiation field. The reconstruction processor generates first volume data in accordance with the specified first reconstruction conditions.

Next, second reconstruction conditions are specified, and the reconstruction processor generates second volume data. In this operation example, first volume data irradiation field and second volume data irradiation field overlap one another. For example, it is a case such that the image based on the second volume data indicates a wide area, while the image based on the first volume data indicates a narrow area (the focused area, and the like). A positional relationship information generating unit of the X-ray image acquisition apparatus acquires positional information, based on the projection data, related to the volume data of each irradiation field similarly specified as in the first embodiment, and generates positional relationship information by coordinating these two pieces of acquired positional information.

Next, the X-ray image acquisition apparatus generates wide area two-dimensional images (hereinafter, referred to as “wide area images”) based on the second volume data. Furthermore, the X-ray image acquisition apparatus generates narrow area two-dimensional images (hereinafter, referred to as “narrow area images”) based on the first volume data. Additionally, the controller causes the display of an FOV image, which expresses the position of the narrow area image within the wide area image, superimposed on the wide area image, based on positional relationship information related to the first volume data and second volume data.

In order to cause the display of the narrow area image, the user uses the operation part, or the like, to specify a FOV image. By specifying this, the controller 41 causes the display to display a narrow area image corresponding to the FOV image. The display format here is the same as that in the first operation example in the first embodiment.

### Second Operation Example

In this operation example, a global image is used as a map to express the distribution of local images. Here, a description is given of the case in which two local images with different FOV are presented. The same process is implemented in cases using three or more local images are displayed.

Similar to the first operation example, the X-ray image acquisition apparatus acquires detection data, while projection data is generated by the X-ray photography device as above. The reconstruction processor reconstructs the projection data based on the reconstruction conditions to which the maximum irradiation field has been applied as the irradiation field condition item, to generate global volume data. In addition, similar to the first example, the reconstruction conditions for each local image are specified. The irradiation field in these reconstruction conditions is included in the maximum irradiation field.

In other words, the reconstruction processor generates first local volume data based on first local image reconstruction conditions. Furthermore, the reconstruction processor generates second local volume data based on second local image reconstruction conditions. At this point, the global volume data, and the first and second local volume data, based on local reconstruction conditions, are acquired.

The positional relationship information generating unit acquires the positional information related to the three sets of volume data based on the projection data, and coordinates the acquired three items of positional information to generate the positional relationship information. Further, two-dimensional global image data is generated based on the global volume data. In addition, two-dimensional first local MPR image data is generated based on the first local volume data, with regard to the same cross-section as the global image data. Furthermore, second local image data is generated based on the second local volume data.

The controller causes the display to display a map expressing the distribution of local FOV within the global image data. In one example of the map, a first local FOV image, expressing the scope of a first local image, and a second local FOV image, expressing the scope of a second local image, are displayed superimposed on the global image. At this time, the user specifies a local FOV image corresponding to one of the local MPR images using the operation part or the like. In response to this specification, the controller causes the display to display the local image corresponding to the specified local FOV image. The display format in this case is the same as that in the second operation example of the first embodiment.

The X-ray image acquisition apparatus forms a first image by reconstructing the acquired data with the first reconstruction conditions, and forms a second image by reconstructing the data with the second reconstruction conditions. In addition, the X-ray image acquisition apparatus generates positional relationship information expressing the positional relationship between the first image and the second image. The controller causes the display to display information based on the positional relationship information. Examples of display information include an FOV image, an FOV distribution map and FOV list information. Referring to the display information in the X-ray image acquisition apparatus allows the positional relationship between the images reconstructed based on the different reconstruction conditions to be simply ascertained.

### <Application to Ultrasound Imaging Apparatus>

The aforementioned first embodiment and second embodiment may be applied to an ultrasound image acquisition apparatus. Ultrasound image acquisition apparatus is configured by comprising a main unit and an ultrasound probe, connected by a cable and a connector. The ultrasound probe is provided with an ultrasound transducer and a transmission/reception controller. The ultrasound transducer may be configured either a one-dimensional or a two-dimensional array. For example, in the case of an ultrasound transducer with a one-dimensional array positioned in the scanning direction, a one-dimensional array mechanically oscillatable probe is used in an orthogonal direction to the scanning direction (the oscillation direction).

The main unit is provided with a controller, a transceiver, a signal processor, an image generating unit, and the like. The transceiver is provided with a transmitter and a receiver, which supplies electric signals to the ultrasound probe causing the generation of ultrasound waves, and receives echo signals received by the ultrasound probe. The transmitter is provided with a clock generation circuit, a transmission delay circuit and a pulsar circuit. The clock generation circuit generates clock signals, which determine the timing of the ultrasound signal transmission, and the transmission frequency. The transmission delay circuit adds a delay at the time of ultrasound wave transmission and performs transmission focusing. The pulsar circuit has multiple pulsars equivalent to the number of individual channels corresponding to each of the ultrasound oscillators. The pulsar circuit generates a drive pulse in line with the transmission timing after delay has been applied, and supplies an electric signal to each of the ultrasound transducer in the ultrasound probe.

The controller controls the transmission/reception of ultrasound waves by controlling the transceiver, and causing the transceiver to scan the three-dimensional ultrasound irradiation area. With this ultrasound image acquisition apparatus, the transceiver scans the three-dimensional ultrasound irradiation area within the subject with ultrasound waves, making it possible to acquire multiple pieces of volume data acquired at different times (multiple volume data over a time series).

For example, the transceiver, under the control of the controller, transmits and receives ultrasound waves depthwise, and scans with ultrasound waves in the main scanning direction, and further, scans with ultrasound waves in the secondary scanning direction, orthogonally intersecting the main scanning direction, thereby scanning a three-dimensional ultrasound irradiation area. The transceiver acquires volume data for a three-dimensional ultrasound insonification area from this scan. Next, by repeatedly scanning this three-dimensional ultrasound insonification area with ultrasound waves, the transceiver acquires multiple volume data over a time series at any time.

Specifically, under the control of the controller, the transceiver transmits and receives ultrasound waves sequentially with regard to each of multiple scan lines, in the main scanning direction. Furthermore, the transceiver also, under the control of the controller, transitions to the secondary scanning direction, and as above, transmits and receives ultrasound waves sequentially with regard to each of multiple scan lines in order, in the main scanning direction. In this way, the transceiver, under the control of the controller, transmits and receives ultrasound waves depthwise while scanning with ultrasound waves in the main direction, and furthermore, scans with ultrasound waves in the secondary direction, thereby acquiring volume data in relation to the three-dimensional ultrasound irradiation area. Under the control of the controller, the transceiver repeatedly scans the three-dimensional ultrasound insonification area using ultrasound waves, acquiring multiple volume data over a time series.

The storage pre-saves scan conditions, including information related to the three-dimensional ultrasound insonification area, the number of scan lines included in the ultrasound insonification area, the scan line density and the order in which the ultrasound waves for each scan line has been transmitted and received (transmission/reception sequence), and the like. If, for example, the operator inputs scan conditions, the controller controls the transmission/reception of the ultrasound waves by the transceiver in accordance with the information representing the scan conditions. As a result, the transceiver transmits and receives ultrasound waves along each of the scan lines as described above, in order in accordance with the transmission/reception sequence.

The signal processor is provided with a B mode processor. The B mode processor generates images from the echo amplitude information. Specifically, the B mode processor implements band path filtering on the received signal output from a transceiver 3, and subsequently detects the output signal envelope curve. Next, the B mode processor subjects the detected data to compression via logarithmic conversion, and converts the echo amplitude information into an image.

The image generating unit converts the signal-processed data into coordinate system data based on spatial coordinates (digital scan conversion). For example, if a volume scan is being implemented, the image generating unit may receive volume data from the signal processor, and subject the volume data to volume rendering, thereby generating three-dimensional image data expressing tissues in three dimensions. Furthermore, the image generating unit may subject the volume data to MPR processing, thereby generating MPR image data. The image generating unit then outputs ultrasound image data such as the three-dimensional image data and MPR image data to the storage.

As in the second embodiment, the information acquisition device operates as an “acquisition device” when implementing a 4D scan. In other words, the information acquisition device acquires information indicating the acquisition timing related to the detection data continuously acquired during the 4D scan. The acquisition timing is the same as that in the second embodiment.

For the case in which an ECG signal is acquired from the subject, the information acquisition device receives the ECG signal from outside the ultrasound image acquisition apparatus and stores the ultrasound image data, after coordinating the ultrasound image data with the cardiac time phase received at the timing the data is generated by the ultrasound image data. For example, by scanning the subject's heart with ultrasound waves, image data expressing the heart at each cardiac phase is acquired. In other words, an ultrasound image acquisition apparatus 1 acquires 4D volume data expressing the heart.

The ultrasound image acquisition apparatus can scan the heart of the subject with ultrasound waves over the course of more than one cardiac cycle. As a result, the ultrasound image acquisition apparatus acquires multiple volume data (4D image data) expressing the heart over the course of more than one cardiac cycle. Furthermore, if an ECG signal is acquired, the information acquisition device coordinates each volume data with the cardiac time phase when the volume data is received at the timing the data is generated, and stores the volume data and the cardiac time phase. As a result, multiple volume data can all be coordinated with the cardiac phase when the data was generated before being stored.

In some cases, the information acquisition device may acquire multiple time phases over a time series related to lung movement from a breathing monitor. Alternatively, it may acquire multiple time phases over a time series related to multiple contrast timings from a contrast agent injector controller, a device for observing the contrast state, a timer function of a microprocessor, or the like. Multiple contrast timings are, for example, multiple coordinates on a temporal axis with the point at which the contrast agent was administered as a starting point.

It is possible to apply the operation examples described in the second embodiment to this type of ultrasound image acquisition apparatus. Further, similar to the other embodiments, changing the ultrasound insonification area within the ultrasound image acquisition apparatus allows:

(1) the display of two or more images in which the ultrasound insonification areas overlap;

(2) the use of the global image as a map indicating the distribution of local images; and

(3) the display of a list indicating ultrasound insonification areas of two or more images.

As a result, it is possible to apply operation examples 1 to 3 in the first embodiment to the ultrasound image acquisition apparatus. Further, by storing the scanning conditions included in the image generation conditions, it is possible to display the settings of the scan conditions. In other words, the fourth operation example in the first embodiment can be applied to the ultrasound image acquisition apparatuses.

### <Application to an MRI Apparatus>

The first and second embodiments can both be applied to an MRI apparatus. MRI apparatus utilizes the phenomenon of nuclear magnetic resonance (NMR), in which the nuclear spin in a desired area of the subject placed in a magnetostatic field is magnetically excited by high frequency signals of Larmor frequency. Furthermore, the MRI apparatus measures density distribution, relaxation time distribution, and the like based on a FID (free induction decay) signal and echo signal generated at the time of the excitation. Additionally, the MRI apparatus displays an image of an arbitrary cross-section of the subject from the measurement data.

The MRI apparatus comprises a scanner. The scanner is provided with a coach, a magnetostatic field magnet, an inclined magnetic field generator, a high-frequency magnetic field generator, and a receiver. The subject is placed on the coach. The magnetostatic field magnet forms a uniform magnetic field in the space at which the subject is placed. In addition, the inclined magnetic field generator provides a magnetic field gradient to the magnetostatic field. The high-frequency magnetic field generator causes an atomic nucleus of an atom constituting tissues of the subject to begin nuclear magnetic resonance. The receiver receives an echo signal generated from the subject due to the nuclear magnetic resonance. The scanner generates a uniform magnetostatic field around the subject, using the magnetostatic field magnet, in either the rostrocaudal direction or in the direction orthogonally intersecting the body axis. Furthermore, the scanner applies an inclined magnetic field to the subject using the inclined magnetic field generator. Next, the scanner transmits a high-frequency pulse in the direction of the subject using the high-frequency magnetic field generator, causing nuclear magnetic resonance. The scanner then detects the echo signal radiating from the nuclear magnetic resonance of the subject, using the receiver. The scanner outputs the detected echo signal to the reconstruction processor.

The reconstruction processor implements processing such as Fourier conversion, correction coefficient calculation, image reconstruction, and the like to the echo signal received by the scanner. As a result, the reconstruction processor generates an image expressing the spatial density and the spectrum of the atomic nucleus. A cross-section image is generated as a result of processing by the scanner and the reconstruction processor described above. The processes above are applied to the three-dimensional area and volume data is generated.

The operation examples described in the first embodiment can be applied to this type of MRI apparatus. Furthermore, the operation examples described in the second embodiment can also be applied to MRI apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### DESCRIPTION OF SYMBOLS

1 X-ray CT apparatus
10 Gantry apparatus
11 X-ray generator
12 X-ray detector
13 Rotator
14 High-voltage generator
15 Gantry driver
16 X-ray collimator
17 Collimator driver
18 Data acquisition unit
30 Coach apparatus
40 Console device
41 Controller
411 Display controller
412 Information acquisition device
42 Scan controller
43 Processor
431 Pre-processor
432 Reconstruction processor
433 Rendering processor
434 Positional relationship information generator
44 Storage
45 Display
46 Operation part

1. A medical image processing apparatus, comprising:
an acquisition unit configured to scan a subject and acquire three-dimensional data;
an image formation unit configured to form a first image and a second image according to a first image generation condition and a second image generation condition, based on the acquired data;
a generating unit configured to generate positional relationship information expressing a positional relationship between the first image and the second image, based on the acquired data;
a controller configured to cause a display to display display information expressing the positional relationship, based on the positional relationship information.

2. The medical image processing apparatus according to claim 1 is an X-ray CT apparatus, wherein
the first image generation conditions for the X-ray CT apparatus are first reconstruction conditions or first image processing conditions, while the second image generation conditions are second reconstruction conditions or second image processing conditions.

3. The medical image processing apparatus according to claim 2, wherein the image formation unit comprises:
a pre-processor configured to implement pre-processing on the data acquired by the acquisition unit to generate projection data;
a reconstruction processor configured to generate first volume data and second volume data by implementing reconstruction processing on the projection data based on the first reconstruction conditions and the second reconstruction conditions; and
a rendering processor configured to form the first image and the second image by implementing rendering processing on the first volume data and the second volume data, respectively, wherein
the generating unit is configured to generate the positional relationship information based on the projection data.

4. The medical image processing apparatus according to claim 2, wherein
the acquisition unit is configured to acquire a scanogram by fixing a radiation direction of X-rays to scan the subject, and
the generating unit is configured to generate the positional relationship information based on the scanogram.

5. The medical image processing apparatus according to claim 3, wherein
the first image generation conditions and the second image generation conditions comprise a mutually overlapping scan range as one of their condition items, and
the controller is configured to cause a scan range image indicating the first image scan range to be displayed, overlapping the second image, as the display information.

6. The medical image processing apparatus according to claim 5, additionally configured to comprise
an operation part, wherein
when the scan range image is specified by using the operation part, the controller is configured to cause the display to display the first image.

7. The medical image processing apparatus according to claim 6, wherein
when the operation part is used to specify scan range image, the controller is configured to implement the any one of the following controls: a first display control configured to switching display from the second image to the first image; a second display control configured to display the first image and the second image in parallel; and a third display control configured to display the first image and the second image superimposed on one another.

8. The medical image processing apparatus according to claim 5, further comprising
an operation part, wherein
when the operation part is operated while the second image is displayed on the display, the controller is configured to cause the scan range image to be displayed superimposed on the second image.

9. The medical image processing apparatus according to claim 5, wherein
the image formation unit is configured to form a third image according to third image generation conditions comprising a maximum scan range as one of the settings used in the scan range condition items, and
the controller is configured to cause the scan range image of the first image and the scan range image of the second image to be displayed superimposed on the third image as the display information.

10. The medical image processing apparatus according to claim 1, further comprising
an operation part, wherein
the first image generation conditions and the second image generation conditions respectively comprise a scan range as condition items,
the controller is configured to cause the display to display a list of scan range information indicating the scan range of the first image and another scan range information indicating the scan range of the second image, as the display information, and
when the scan range information is specified by using the operation part, the controller is configured to cause the display to display an image corresponding to the specified scan range.

11. The medical image processing apparatus according to claim 10, wherein
the image formation unit is configured to form a third image according to the third image generation conditions comprising a maximum scan range as one of the settings used in the scan range condition items, and
the controller is configured to cause the first image scan range image information and the second image scan range image information to be displayed superimposed on the scan range information indicating the maximum scan range, as the list of information.

12. The medical image processing apparatus according to claim 2, wherein
the controller is configured to cause the display to display one or more of the condition item settings, included in the first image generation conditions and the second image generation conditions.

13. The medical image processing apparatus according to claim 12, wherein
for cases in which there are any condition item having differences in the settings between the first image generation conditions and the second image generation conditions, the controller is configured to cause the condition item settings to be displayed in a manner different from that of the other condition item settings.

14. The medical image processing apparatus according to claim 1, wherein
the acquisition unit is configured to repeatedly scan a specific site of the subject and sequentially acquires data,
the medical image processing apparatus further comprises an acquisition part configured to acquire multiple pieces of information indicating acquisition timing of data acquired sequentially from the acquisition unit,
the image formation unit is configured to form first image based on the first data acquired at a first acquisition timing among the sequentially acquired data, and the second image based on second data acquired at a second acquisition timing among the sequentially acquired data, and
the controller is configured to cause the display to display the first image and the second image, based on information indicating such the first acquisition timing and the second acquisition timing that the display displays the first image and the second image based on the positional relationship information, the information indicating the first acquisition timing and the information indicating the second acquisition timing.

15. The medical image processing apparatus according to claim 14 which is an X-ray CT apparatus, wherein
the first image generation conditions in the X-ray CT apparatus are first reconstruction conditions or first image processing conditions, while second image generation conditions are second reconstruction conditions or second image processing conditions, and wherein
the image formation unit comprises:
a pre-processor configured to generate projection data by implementing pre-processing on sequentially acquired data;
a reconstruction processor configured to generate first volume data by implementing reconstruction processing on the projection data, based on the first reconstruction conditions, and generate second volume data by implementing reconstruction processing on the projection data, based on the second reconstruction conditions; and
a rendering processor configured to form the first image by implementing rendering processing on the first volume data, and form the second image by implementing rendering processing on the second volume data, and wherein
the generating unit is configured to generate the positional relationship information based on the projection data.

16. The medical image processing apparatus according to claim 14, wherein the controller is configured to cause the display to display time series information that indicates the multiple acquisition timings of the sequential acquisition of data by the acquisition unit, and present the first acquisition timing and the second acquisition timing, respectively, based on the time series information.

17. The medical image processing apparatus according to claim 16, wherein the controller is configured to cause a temporal axis image indicating temporal axis to be displayed as the time series information, and present coordinate positions, corresponding to the first acquisition timing and the second acquisition timing, respectively, on the temporal axis image.

18. The medical image processing apparatus according to claim 16, wherein the controller is configured to cause time phase information indicating time phases of the movement of the internal organs being scanned to be displayed as time series information, and present time phase information indicating time phases corresponding to the first acquisition timing and the second acquisition timing, respectively.

19. The medical image processing apparatus according to claim 16, wherein when the subject is scanned upon administration of a contrast agent, the controller is configured to cause contrast information indicating the contrast timing to be displayed as the time series information, and present contrast information indicating contrast timing corresponding to the first acquisition timing and the second acquisition timing, respectively.

20. The medical image processing apparatus according to claim 16, wherein, when one or more of the acquisition timings indicated in the time series information are specified by using an operation part, the controller is configured to cause the display to display an image formed by the image formation unit based on the data acquired at each specified acquisition timing.

21. The medical image processing apparatus according to claim 16, wherein, when one or more of the acquisition timings in the time series information are specified by using an operation part, the controller is configured to cause the display to display a thumbnail of the image, formed by the image formation unit based on the data acquired at each specified acquisition timing.

22. The medical image processing apparatus according to claim 14, wherein
the first image generation conditions and the second image generation conditions comprise a mutually overlapping scan range as one of their condition items,
the image formation unit is configured to form multiple images in line with the time series as the first image, and
the controller is configured to cause a moving image based on the aforementioned multiple images to be displayed superimposed on the second image, based on the mutually overlapping scan range.

23. The medical image processing apparatus according to claim 22, wherein the controller is configured to synchronize switching display between the multiple images in order to display the moving image, in addition to causing switching display of information indicating multiple acquisition timings corresponding to the multiple images.

24. The medical image processing apparatus according to claim 14, wherein
the first image generation conditions and the second image generation conditions comprise a mutually overlapping scan range as one of their condition items, and
the controller is configured to cause a scan range image expressing the scan range in place of the first image, to be displayed superimposed on the second image.

25. The medical image processing apparatus according to claim 24, wherein,
when the scan range image is specified by using an operation part, the controller is configured to cause the display to display the first image.

26. The medical image processing apparatus according to claim 25, wherein,
when the scan range image is specified by using the operation part, the controller is configured to implement any one of the following controls: a first display control of switching display from the second image to the first image; a second display control of displaying the first image and the second image in parallel; and a third display control of displaying the first image and the second image superimposed on one another.

27. The medical image processing apparatus according to claim 24, wherein,
in response to an operation part being operated when the second image is displayed on the display, the controller is configured to cause the scan range image to be displayed superimposed on the second image.

28. The medical image processing apparatus according to claim 24, wherein
the image formation unit is configured to form a third image according to third image generation conditions, which include a maximum scan range as the scan range condition item settings, and
the controller is configured to cause the scan range image of the first image and the scan range image of the second image to be displayed superimposed on the third image, in place of displaying the first image and the second image.

29. The medical image processing apparatus according to claim 14, wherein
the controller is configured to cause the display to display one or more condition item settings, included in the first image generation conditions and the second image generation conditions.

30. The medical image processing apparatus according to claim 29, wherein,
for cases in which there are any condition item having differences in the settings between the first image generation conditions and the second image generation conditions, the controller is configured to cause the condition item settings to be displayed in a manner different from that of the other condition item settings.
